(19) United States
(12) Patent Application Publication
(10) Pub. No.: US 2024/0214854 A1
(43) Pub. Date: Jun. 27, 2024

(54) TECHNIQUES FOR TRANSMITTING AN EVENT-TRIGGERED NON-SERVING CELL BEAM REPORT

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 18/557,271

(22) PCT Filed: Jul. 2, 2021
(86) PCT No.: PCT/CN2021/104175

§ 371 Date: Oct. 25, 2023

(51) Int. Cl. H04W 24/10; H04B 17/318; H04W 80/02

(52) U.S. Cl. CPC H04W 24/10; H04B 17/328; H04W 80/02

(57) ABSTRACT

This disclosure provides systems, methods and apparatus, including computer programs encoded on computer storage media, for a user equipment (UE)-initiated non-serving cell beam reporting mechanism. In one aspect, a UE may transmit a resource request that requests resources over which to transmit a non-serving cell beam report for a set of beams associated with one or more non-serving cells if the set of beams satisfy a Layer 1 (L1)-based condition. For example, the UE may transmit the resource request depending on whether a beam quality of each of the set of beams or an average beam quality of the set of beams satisfies a quality threshold. The UE may receive a request for the non-serving cell beam report responsive to transmitting the resource request and may transmit the non-serving cell beam report over resources indicated by the request for the non-serving cell beam report.

### CROSS REFERENCE

The present application is a 371 national stage filing of International PCT Application No. PCT/CN2021/104175 by YUAN et al. entitled “TECHNIQUES FOR TRANSMITTING AN EVENT-TRIGGERED NON-SERVING CELL BEAM REPORT,” filed Jul. 2, 2021, which is assigned to the assignee hereof, and which is expressly incorporated by reference in its entirety herein.

### TECHNICAL FIELD

This disclosure relates to wireless communications, including techniques for transmitting an event-triggered non-serving cell beam report.

### DESCRIPTION OF THE RELATED TECHNOLOGY

Wireless communications systems are widely deployed to provide various types of communication content such as voice, video, packet data, messaging, broadcast, and so on. These systems may be capable of supporting communication with multiple users by sharing the available system resources (for example, time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations (BSs) or one or more network access nodes, each simultaneously supporting communication for multiple communication devices, which may be otherwise known as user equipment (UE).

In some systems, a UE may be capable of inter-cell mobility. In such systems, the UE may switch from communicating with a first cell to communicating with a second cell.

### SUMMARY

The systems, methods and devices of this disclosure each have several innovative aspects, no single one of which is solely responsible for the desirable attributes disclosed herein.

One innovative aspect of the subject matter described in this disclosure can be implemented in a method for wireless communications at a user equipment (UE). The method may include transmitting a resource request associated with a non-serving cell beam report, receiving, responsive to the resource request, a request for the non-serving cell beam report, and transmitting the non-serving cell beam report, where the non-serving cell beam report conveys beam quality information for a set of beams associated with one or more non-serving cells.

Another innovative aspect of the subject matter described in this disclosure can be implemented in an apparatus for wireless communications at a UE. The apparatus may include a first interface, a second interface, and a processing system. The first interface may be configured to output a resource request associated with a non-serving cell beam report. The first interface or the second interface may be configured to obtain, responsive to the resource request, a request for the non-serving cell beam report. The first interface or the second interface may be configured to output the non-serving cell beam report, where the non-serving cell beam report conveys beam quality information for a set of beams associated with one or more non-serving cells.

Another innovative aspect of the subject matter described in this disclosure can be implemented in an apparatus for wireless communications at a UE. The apparatus may include a processor, memory coupled with the processor, and instructions stored in the memory. The instructions may be executable by the processor to cause the apparatus to transmit a resource request associated with a non-serving cell beam report, receive, responsive to the resource request, a request for the non-serving cell beam report, and transmit the non-serving cell beam report, where the non-serving cell beam report conveys beam quality information for a set of beams associated with one or more non-serving cells.

Another innovative aspect of the subject matter described in this disclosure can be implemented in another apparatus for wireless communications at a UE. The apparatus may include means for transmitting a resource request associated with a non-serving cell beam report, means for receiving, responsive to the resource request, a request for the non-serving cell beam report, and means for transmitting the non-serving cell beam report, where the non-serving cell beam report conveys beam quality information for a set of beams associated with one or more non-serving cells.

Another innovative aspect of the subject matter described in this disclosure can be implemented in a non-transitory computer-readable medium storing code for wireless communications at a UE. The code may include instructions executable by a processor to transmit a resource request associated with a non-serving cell beam report, receive, responsive to the resource request, a request for the non-serving cell beam report, and transmit the non-serving cell beam report, where the non-serving cell beam report conveys beam quality information for a set of beams associated with one or more non-serving cells.

Some examples of the method, apparatuses, and non-transitory computer-readable medium described herein may further include operations, features, means, or instructions for receiving an indication of a set of beam measurement resources over which the UE is to measure the set of beams associated with the one or more non-serving cells and measuring a reference signal corresponding to each of the set of beams associated with the one or more non-serving cells over the set of beam measurement resources.

In some examples of the method, apparatuses, and non-transitory computer-readable medium described herein, measuring the reference signal corresponding to each of the set of beams associated with the one or more non-serving cells may include operations, features, means, or instructions for measuring that a respective beam quality of each beam of the set of beams fails to satisfy a quality threshold, where transmitting the resource request associated with the non-serving cell beam report may be a result of the respective beam quality of each beam of the set of beams failing to satisfy the quality threshold.

In some examples of the method, apparatuses, and non-transitory computer-readable medium described herein, measuring the reference signal corresponding to each of the set of beams associated with the one or more non-serving cells may include operations, features, means, or instructions for measuring that an average beam quality of the set of beams fails to satisfy a quality threshold, where transmitting the resource request associated with the non-serving cell beam report may be a result of the average beam quality of the set of beams failing to satisfy the quality threshold.

In some examples of the method, apparatuses, and non-transitory computer-readable medium described herein, measuring the reference signal corresponding to each of the set of beams associated with the one or more non-serving cells may include operations, features, means, or instructions for measuring that an average beam quality of the set of beams satisfies a quality threshold, where transmitting the resource request associated with the non-serving cell beam report may be a result of the average beam quality of the set of beams satisfying the quality threshold.

In some examples of the method, apparatuses, and non-transitory computer-readable medium described herein, measuring the reference signal corresponding to each of the set of beams associated with the one or more non-serving cells may include operations, features, means, or instructions for measuring that an average beam quality of the set of beams may have changed greater than a threshold amount relative to a previous average beam quality of the set of beams obtained from a previous measurement, where transmitting the resource request associated with the non-serving cell beam report may be a result of the average beam quality of the set of beams changing greater than the threshold amount relative to the previous average beam quality of the set of beams obtained from the previous measurement.

One innovative aspect of the subject matter described in this disclosure can be implemented in a method for wireless communications at a network entity. The method may include receiving, from a UE, a resource request associated with a non-serving cell beam report, transmitting, to the UE and responsive to the resource request, a request for the non-serving cell beam report, and receiving, from the UE, the non-serving cell beam report, where the non-serving cell beam report conveys beam quality information for a set of beams associated with one or more non-serving cells.

Another innovative aspect of the subject matter described in this disclosure can be implemented in an apparatus for wireless communications at a network entity. The apparatus may include a first interface, a second interface, and a processing system. The first interface may be configured to obtain, from a UE, a resource request associated with a non-serving cell beam report. The first interface or the second interface may be configured to output, to the UE and responsive to the resource request, a request for the non-serving cell beam report. The first interface or the second interface may be configured to obtain, from the UE, the non-serving cell beam report, where the non-serving cell beam report conveys beam quality information for a set of beams associated with one or more non-serving cells.

Another innovative aspect of the subject matter described in this disclosure can be implemented in another apparatus for wireless communications at a network entity. The apparatus may include a processor, memory coupled with the processor, and instructions stored in the memory. The instructions may be executable by the processor to cause the apparatus to receive, from a UE, a resource request associated with a non-serving cell beam report, transmit, to the UE and responsive to the resource request, a request for the non-serving cell beam report, and receive, from the UE, the non-serving cell beam report, where the non-serving cell beam report conveys beam quality information for a set of beams associated with one or more non-serving cells.

Another innovative aspect of the subject matter described in this disclosure can be implemented in another apparatus for wireless communications at a network entity. The apparatus may include means for receiving, from a UE, a resource request associated with a non-serving cell beam report, means for transmitting, to the UE and responsive to the resource request, a request for the non-serving cell beam report, and means for receiving, from the UE, the non-serving cell beam report, where the non-serving cell beam report conveys beam quality information for a set of beams associated with one or more non-serving cells.

Another innovative aspect of the subject matter described in this disclosure can be implemented in a non-transitory computer-readable medium storing code for wireless communications at a network entity. The code may include instructions executable by a processor to receive, from a UE, a resource request associated with a non-serving cell beam report, transmit, to the UE and responsive to the resource request, a request for the non-serving cell beam report, and receive, from the UE, the non-serving cell beam report, where the non-serving cell beam report conveys beam quality information for a set of beams associated with one or more non-serving cells.

In some examples of the method, apparatuses, and non-transitory computer-readable medium described herein, receiving the resource request associated with the non-serving cell beam report may include operations, features, means, or instructions for receiving an indication of a configuration identifier for the non-serving cell beam report.

In some examples of the method, apparatuses, and non-transitory computer-readable medium described herein, transmitting the request for the non-serving cell beam report may include operations, features, means, or instructions for transmitting an indication of a set of resources over which the UE is to transmit the non-serving cell beam report, where the non-serving cell beam report may be received over the set of resources in accordance with the request for the non-serving cell beam report.

Some examples of the method, apparatuses, and non-transitory computer-readable medium described herein may further include operations, features, means, or instructions for transmitting the request for the non-serving cell beam report includes transmitting an indication of a content to be included in the non-serving cell beam report and receiving the non-serving cell beam report in accordance with the request includes receiving a beam index for each beam of the set of beams and, for each beam of the set of beams, a reference signal receive power (RSRP) measurement in accordance with the content indicated by the request for the non-serving cell beam report.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 illustrates an example wireless communications system that supports techniques for transmitting an event-triggered non-serving cell beam report.

FIG. 2 illustrates an example signaling diagram that supports techniques for transmitting an event-triggered non-serving cell beam report.

FIG. 3 illustrates an example control element that supports techniques for transmitting an event-triggered non-serving cell beam report.

FIG. 4 illustrates an example communication timeline that supports techniques for transmitting an event-triggered non-serving cell beam report.

FIG. 5 illustrates an example process flow that supports techniques for transmitting an event-triggered non-serving cell beam report.

FIGS. 6 and 7 show block diagrams of example devices that support techniques for transmitting an event-triggered non-serving cell beam report.

FIGS. 8 and 9 show flowcharts illustrating example methods that support techniques for transmitting an event-triggered non-serving cell beam report.

Like reference numbers and designations in the various drawings indicate like elements.

### DETAILED DESCRIPTION

The following description is directed to some implementations for the purposes of describing the innovative aspects of this disclosure. However, a person having ordinary skill in the art will readily recognize that the teachings herein can be applied in a multitude of different ways. The described implementations may be implemented in any device, system or network that is capable of transmitting and receiving radio frequency (RF) signals according to any of the Institute of Electrical and Electronics Engineers (IEEE) 16.11 standards, or any of the IEEE 802.11 standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, or further implementations thereof, technology.

In some wireless communications systems, a user equipment (UE) may support Layer 1 (L1)- or Layer 2 (L2)-centric inter-cell mobility or inter-cell multi-transmission and reception point (TRP) communication and, as such, may support a number of beams, including related measurement and reporting, associated with one or more non-serving cells. For example, in such systems in which the UE supports L1- or L2-centric inter-cell mobility or inter-cell multi-TRP (mTRP) communication, the UE may be capable of measuring the number of beams associated with the one or more non-serving cells and reporting the non-serving cell beam measurements to a network entity (such as a serving cell, a base station (BS), a component of a BS, or a TRP). In some examples, the UE may measure the number of beams associated with the one or more non-serving cells and may report the non-serving cell beam measurements to the network entity as a result of receiving a request for a non-serving cell beam report from the network entity. Reporting non-serving cell beam measurements exclusively upon request from the network entity may potentially introduce latency and overhead in reporting some beam measurement information. Such latency may be a function of how long the UE waits between acquiring beam measurements and receiving a request from the network entity to report the beam measurements. For example, the UE may lack a signaling mechanism to enable a UE-initiated non-serving cell beam report, which may inhibit reporting flexibility and provide for a relatively less dynamic communication environment for the UE.

In some implementations of the present disclosure, the UE may support an L1-based event-driven reporting mechanism according to which the UE requests resources for a non-serving cell beam report as a result of the number of beams associated with the one or more non-serving cells satisfying a condition (such as a triggering condition). For example, the UE may transmit a request to the network entity for resources over which to transmit a non-serving cell beam report if each beam of the number of non-serving cell beams has a beam quality that fails to satisfy a quality threshold, if an average beam quality of the number of non-serving cell beams fails to satisfy a quality threshold, if the average beam quality of the number of non-serving cell beams satisfies a quality threshold, or if the average beam quality of the number of non-serving cell beams changes more than a threshold amount relative to a previous reporting or measurement, or any combination thereof. The UE may send the request for the resources over which to transmit a non-serving cell beam report via a dedicated scheduling request or via a dedicated medium access control (MAC) control element (MAC-CE) and the UE may receive, responsive to the request, an indication of the resources over which to transmit the non-serving cell beam report as well as a content to be included in the non-serving cell beam report. Accordingly, the UE may generate the non-serving cell beam report in accordance with the requested content and may transmit the non-serving cell beam report over the indicated resources.

Particular implementations of the subject matter described in this disclosure can be implemented to realize one or more of the following potential advantages. For example, as a result of employing an L1-based event-driven reporting mechanism, the UE may provide non-serving cell beam measurements more dynamically, which may facilitate more dynamic or flexible mobility to a non-serving cell. In other words, the UE may provide non-serving cell beam measurements as those non-serving cell beam measurements may indicate information that is either relevant or potentially impactful to UE mobility or measurement. For example, the UE may provide non-serving cell beam measurements if the measurements indicate that beam failure recovery (BFR) for one or more non-serving cells is warranted, that one or more non-serving cells may be activated for new cell measurement, or that one or more non-serving cells may be deactivated from cell measurement. As such, the UE may provide the network entity with relevant non-serving cell beam information at any given time and the network entity may use the non-serving cell beam information for UE mobility or measurement configurations, which may save signaling overhead relative to being configured with periodic measurement and reporting, and may result in an establishment of more reliable communication links or a measurement of cells that are relatively more likely to provide reliable communication links for the UE. Further, and as a result of the establishment or likely establishment of such relatively more reliable communication links, the UE and the network entity may experience a greater likelihood for successful communication, greater system throughput, higher data rates, and greater spectral efficiency, among other examples.

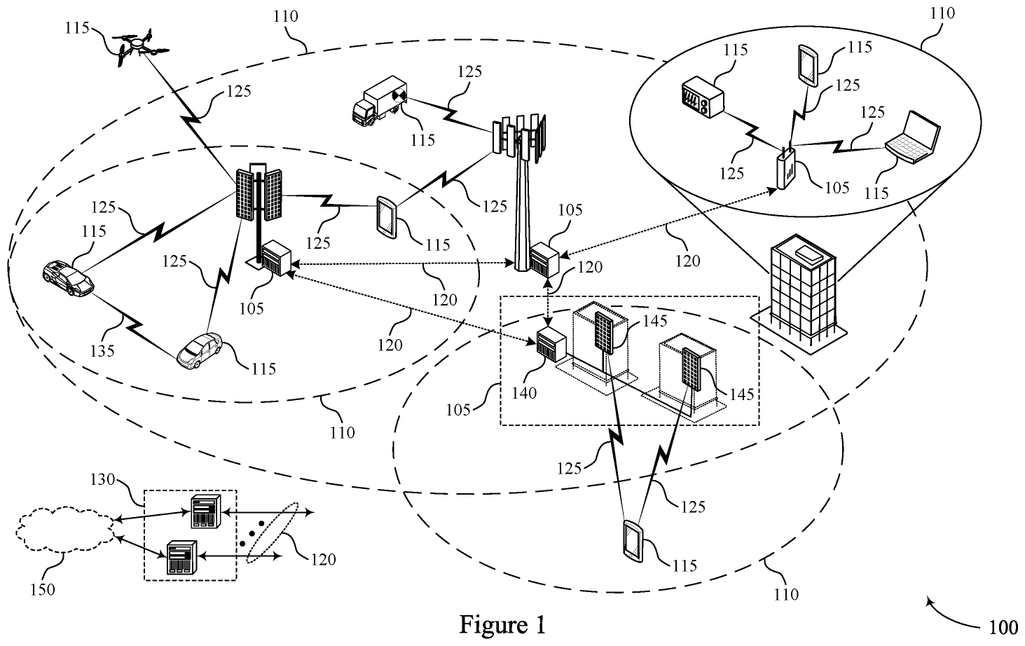

FIG. 1 illustrates an example of a wireless communications system 100 that supports techniques for transmitting an event-triggered non-serving cell beam report. The wireless communications system 100 may include one or more BSs 105, one or more UEs 115, and a core network 130. In some implementations, the wireless communications system 100 may be a Long Term Evolution (LTE) network, an LTE-Advanced (LTE-A) network, an LTE-A Pro network, or a New Radio (NR) network. In some implementations, the wireless communications system 100 may support enhanced broadband communications, ultra-reliable (for example, mission critical) communications, low latency communications, communications with low-cost and low-complexity devices, or any combination thereof.

The BSs 105 may be dispersed throughout a geographic area to form the wireless communications system 100 and may be devices in different forms or having different capabilities. The BSs 105 and the UEs 115 may wirelessly communicate via one or more communication links 125. Each BS 105 may provide a coverage area 110 over which the UEs 115 and the BS 105 may establish one or more communication links 125. The coverage area 110 may be an example of a geographic area over which a BS 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the BSs 105, or network equipment (for example, core network nodes, relay devices, integrated access and backhaul (IAB) nodes, or other network equipment), as shown in FIG. 1.

The BSs 105 may communicate with the core network 130, or with one another, or both. For example, the BSs 105 may interface with the core network 130 through one or more backhaul links 120 (for example, via an S1, N2, N3, or another interface). The BSs 105 may communicate with one another over the backhaul links 120 (for example, via an X2, Xn, or another interface) either directly (for example, directly between BSs 105), or indirectly (for example, via core network 130), or both. In some implementations, the backhaul links 120 may be or include one or more wireless links.

One or more of the BSs 105 described herein may include or may be referred to by a person having ordinary skill in the art as a base transceiver station, a radio BS, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” also may be referred to as a unit, a station, a terminal, or a client, among other examples. A UE 115 also may include or may be referred to as a personal electronic device such as a cellular phone, a personal digital assistant (PDA), a tablet computer, a laptop computer, or a personal computer. In some implementations, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other implementations.

The UEs 115 described herein may be able to communicate with various types of devices, such as other UEs 115 that may sometimes act as relays as well as the BSs 105 and the network equipment including macro eNBs or gNBs, small cell eNBs or gNBs, or relay BSs, among other implementations, as shown in FIG. 1.

The UEs 115 and the BSs 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (for example, a bandwidth part (BWP)) that is operated according to one or more physical layer channels for a given radio access technology (for example, LTE, LTE-A, LTE-A Pro, NR). Each physical layer channel may carry acquisition signaling (for example, synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some implementations (for example, in a carrier aggregation configuration), a carrier also may have acquisition signaling or control signaling that coordinates operations for other carriers. A carrier may be associated with a frequency channel (for example, an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (for example, of the same or a different radio access technology).

The communication links 125 shown in the wireless communications system 100 may include uplink transmissions from a UE 115 to a BS 105, or downlink transmissions from a BS 105 to a UE 115. Carriers may carry downlink or uplink communications (for example, in an FDD mode) or may be configured to carry downlink and uplink communications (for example, in a TDD mode).

A carrier may be associated with a particular bandwidth of the radio frequency spectrum, and in some implementations the carrier bandwidth may be referred to as a “system bandwidth” of the carrier or the wireless communications system 100. For example, the carrier bandwidth may be one of a number of determined bandwidths for carriers of a particular radio access technology (for example, 1.4, 3, 5, 10, 15, 20, 40, or 80 megahertz (MHz)). Devices of the wireless communications system 100 (for example, the BSs 105, the UEs 115, or both) may have hardware configurations that support communications over a particular carrier bandwidth or may be configurable to support communications over one of a set of carrier bandwidths. In some implementations, the wireless communications system 100 may include BSs 105 or UEs 115 that support simultaneous communications via carriers associated with multiple carrier bandwidths. In some implementations, each served UE 115 may be configured for operating over portions (for example, a sub-band, a BWP) or all of a carrier bandwidth.

Signal waveforms transmitted over a carrier may be made up of multiple subcarriers (for example, using multi-carrier modulation (MCM) techniques such as orthogonal frequency division multiplexing (OFDM) or discrete Fourier transform spread OFDM (DFT-S-OFDM)). In a system employing MCM techniques, a resource element may include one symbol period (for example, a duration of one modulation symbol) and one subcarrier, where the symbol period and subcarrier spacing are inversely related. The quantity of bits carried by each resource element may depend on the modulation scheme (for example, the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (for example, spatial layers or beams), and the use of multiple spatial layers may further increase the data rate or data integrity for communications with a UE 115.

The time intervals for the BSs 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (for example, 10 milliseconds (ms)). Each radio frame may be identified by a system frame number (SFN) (for example, ranging from 0 to 1023).

Each frame may include multiple consecutively numbered subframes or slots, and each subframe or slot may have the same duration. In some implementations, a frame may be divided (for example, in the time domain) into subframes, and each subframe may be further divided into a number of slots. Alternatively, each frame may include a variable number of slots, and the number of slots may depend on subcarrier spacing. Each slot may include a number of symbol periods (for example, depending on the length of the cyclic prefix prepended to each symbol period). In some wireless communications systems 100, a slot may further be divided into multiple mini-slots containing one or more symbols. Excluding the cyclic prefix, each symbol period may contain one or more (for example, N_{f}) sampling periods. The duration of a symbol period may depend on the subcarrier spacing or frequency band of operation.

A subframe, a slot, a mini-slot, or a symbol may be the smallest scheduling unit (for example, in the time domain) of the wireless communications system 100 and may be referred to as a transmission time interval (TTI). In some implementations, the TTI duration (for example, the number of symbol periods in a TTI) may be variable. Additionally, or alternatively, the smallest scheduling unit of the wireless communications system 100 may be dynamically selected (for example, in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (for example, a control resource set (CORESET)) for a physical control channel may be defined by a number of symbol periods and may extend across the system bandwidth or a subset of the system bandwidth of the carrier. One or more control regions (for example, CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (for example, control channel elements (CCEs)) associated with encoded information for a control information format having a given payload size. Search space sets may include common search space sets configured for sending control information to multiple UEs 115 and UE-specific search space sets for sending control information to a specific UE 115.

Each BS 105 may provide communication coverage via one or more cells, for example a macro cell, a small cell, a hot spot, or other types of cells, or any combination thereof. The term “cell” may refer to a logical communication entity used for communication with a BS 105 (for example, over a carrier) and may be associated with an identifier for distinguishing neighboring cells (for example, a physical cell identifier (PCID), a virtual cell identifier (VCID), or others). In some implementations, a cell also may refer to a geographic coverage area 110 or a portion of a geographic coverage area 110 (for example, a sector) over which the logical communication entity operates. Such cells may range from smaller areas (for example, a structure, a subset of structure) to larger areas depending on various factors such as the capabilities of the BS 105. For example, a cell may be or include a building, a subset of a building, or exterior spaces between or overlapping with geographic coverage areas 110, among other implementations.

A macro cell generally covers a relatively large geographic area (for example, several kilometers in radius) and may allow unrestricted access by the UEs 115 with service subscriptions with the network provider supporting the macro cell. A small cell may be associated with a lower-powered BS 105, as compared with a macro cell, and a small cell may operate in the same or different (for example, licensed, unlicensed) frequency bands as macro cells. Small cells may provide unrestricted access to the UEs 115 with service subscriptions with the network provider or may provide restricted access to the UEs 115 having an association with the small cell (for example, the UEs 115 in a closed subscriber group (CSG), the UEs 115 associated with users in a home or office). A BS 105 may support one or multiple cells and also may support communications over the one or more cells using one or multiple component carriers.

In some implementations, a carrier may support multiple cells, and different cells may be configured according to different protocol types (for example, MTC, narrowband IoT (NB-IoT), enhanced mobile broadband (eMBB)) that may provide access for different types of devices.

In some implementations, a BS 105 may be movable and therefore provide communication coverage for a moving geographic coverage area 110. In some implementations, different geographic coverage areas 110 associated with different technologies may overlap, but the different geographic coverage areas 110 may be supported by the same BS 105. In some other implementations, the overlapping geographic coverage areas 110 associated with different technologies may be supported by different BSs 105. The wireless communications system 100 may include, for example, a heterogeneous network in which different types of the BSs 105 provide coverage for various geographic coverage areas 110 using the same or different radio access technologies.

The wireless communications system 100 may support synchronous or asynchronous operation. For synchronous operation, the BSs 105 may have similar frame timings, and transmissions from different BSs 105 may be approximately aligned in time. For asynchronous operation, the BSs 105 may have different frame timings, and transmissions from different BSs 105 may, in some implementations, not be aligned in time. The techniques described herein may be used for either synchronous or asynchronous operations.

Some UEs 115 may be configured to employ operating modes that reduce power consumption, such as half-duplex communications (for example, a mode that supports one-way communication via transmission or reception, but not transmission and reception simultaneously). In some implementations, half-duplex communications may be performed at a reduced peak rate. Other power conservation techniques for the UEs 115 include entering a power saving deep sleep mode when not engaging in active communications, operating over a limited bandwidth (for example, according to narrowband communications), or a combination of these techniques. For example, some UEs 115 may be configured for operation using a narrowband protocol type that is associated with a defined portion or range (for example, set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (for example, mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some implementations, a UE 115 also may be able to communicate directly with other UEs 115 over a device-to-device (D2D) communication link 135 (for example, using a peer-to-peer (P2P) or D2D protocol). One or more UEs 115 utilizing D2D communications may be within the geographic coverage area 110 of a BS 105. Other UEs 115 in such a group may be outside the geographic coverage area 110 of a BS 105 or be otherwise unable to receive transmissions from a BS 105. In some implementations, groups of the UEs 115 communicating via D2D communications may utilize a one-to-many (1:M) system in which each UE 115 transmits to every other UE 115 in the group. In some implementations, a BS 105 facilitates the scheduling of resources for D2D communications. In some other implementations, D2D communications are carried out between the UEs 115 without the involvement of a BS 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (for example, a mobility management entity (MME), an access and mobility management function (AMF)) and at least one user plane entity that routes packets or interconnects to external networks (for example, a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the BSs 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a BS 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or BS 105 may be distributed across various network devices (for example, radio heads and ANCs) or consolidated into a single network device (for example, a BS 105). In various implementations, a BS 105, or an access network entity 140, or a core network 130, or some subcomponent thereof, may be referred to as a network entity.

As described herein, a BS 105 may include components that are located at a single physical location or components located at various physical locations. In examples in which the BS 105 includes components that are located at various physical locations, the various components may each perform various functions such that, collectively, the various components achieve functionality that is similar to a BS 105 that is located at a single physical location. As such, a BS 105 described herein may equivalently refer to a standalone BS 105 or a BS 105 including components that are located at various physical locations. In some implementations, such a BS 105 including components that are located at various physical locations may be referred to as or may be associated with a disaggregated radio access network (RAN) architecture, such as an Open RAN (O-RAN) or Virtualized RAN (VRAN) architecture. In some examples, such components of a BS 105 may include or refer to one or more of a central unit (CU), a distributed unit (DU), or a radio unit (RU).

The wireless communications system 100 may operate using one or more frequency bands, sometimes in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (for example, less than 100 kilometers) compared to transmission using the smaller frequencies and longer waves of the high frequency (HF) or very high frequency (VHF) portion of the spectrum below 300 MHz.

The wireless communications system 100 also may operate in a super high frequency (SHF) region using frequency bands from 3 GHz to 30 GHz, also known as the centimeter band, or in an extremely high frequency (EHF) region of the spectrum (for example, from 30 GHz to 300 GHz), also known as the millimeter band. In some implementations, the wireless communications system 100 may support millimeter wave (mmW) communications between the UEs 115 and the BSs 105, and EHF antennas of the respective devices may be smaller and more closely spaced than UHF antennas. In some implementations, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the BSs 105 and the UEs 115 may employ carrier sensing for collision detection and avoidance. In some implementations, operations in unlicensed bands may be based on a carrier aggregation configuration in conjunction with component carriers operating in a licensed band (for example, LAA). Operations in unlicensed spectrum may include downlink transmissions, uplink transmissions, P2P transmissions, or D2D transmissions, among other transmissions.

A BS 105 or a UE 115 may be equipped with multiple antennas, which may be used to employ techniques such as transmit diversity, receive diversity, multiple-input multiple-output (MIMO) communications, or beamforming. The antennas of a BS 105 or a UE 115 may be located within one or more antenna arrays or antenna panels, which may support MIMO operations or transmit or receive beamforming. For example, one or more BS antennas or antenna arrays may be co-located at an antenna assembly, such as an antenna tower. In some implementations, antennas or antenna arrays associated with a BS 105 may be located in diverse geographic locations. A BS 105 may have an antenna array with a number of rows and columns of antenna ports that the BS 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

The BSs 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (for example, the same codeword) or different data streams (for example, different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which also may be referred to as spatial filtering, directional transmission, or directional reception, is a signal processing technique that may be used at a transmitting device or a receiving device (for example, a BS 105, a UE 115) to shape or steer an antenna beam (for example, a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (for example, with respect to the antenna array of the transmitting device or receiving device, or with respect to some other orientation).

A BS 105 or a UE 115 may use beam sweeping techniques as part of beam forming operations. For example, a BS 105 may use multiple antennas or antenna arrays (for example, antenna panels) to conduct beamforming operations for directional communications with a UE 115. Some signals (for example, synchronization signals, reference signals, beam selection signals, or other control signals) may be transmitted by a BS 105 multiple times in different directions. For example, the BS 105 may transmit a signal according to different beamforming weight sets associated with different directions of transmission. Transmissions in different beam directions may be used to identify (for example, by a transmitting device, such as one or more components of a BS 105, or by a receiving device, such as a UE 115) a beam direction for later transmission or reception by the BS 105.

Some signals, such as data signals associated with a particular receiving device, may be transmitted by one or more components of a BS 105 in a single beam direction (for example, a direction associated with the receiving device, such as a UE 115). In some implementations, the beam direction associated with transmissions along a single beam direction may be determined based on a signal that was transmitted in one or more beam directions. For example, a UE 115 may receive one or more of the signals transmitted by the BS 105 in different directions and may report to the BS 105 an indication of the signal that the UE 115 received with a highest signal quality or an otherwise acceptable signal quality.

In some implementations, transmissions by a device (for example, by one or more components of a BS 105 or a UE 115) may be performed using multiple beam directions, and the device may use a combination of digital precoding or radio frequency beamforming to generate a combined beam for transmission (for example, from one or more components of a BS 105 to a UE 115). The UE 115 may report feedback that indicates precoding weights for one or more beam directions, and the feedback may correspond to a configured number of beams across a system bandwidth or one or more sub-bands. The BS 105 may transmit a reference signal (for example, a cell-specific reference signal (CRS), a channel state information (CSI) reference signal (CSI-RS)), which may be precoded or unprecoded. The UE 115 may provide feedback for beam selection, which may be a precoding matrix indicator (PMI) or codebook-based feedback (for example, a multi-panel type codebook, a linear combination type codebook, a port selection type codebook). Although these techniques are described with reference to signals transmitted in one or more directions by one or more components of a BS 105, a UE 115 may employ similar techniques for transmitting signals multiple times in different directions (for example, for identifying a beam direction for subsequent transmission or reception by the UE 115) or for transmitting a signal in a single direction (for example, for transmitting data to a receiving device).

A receiving device (for example, a UE 115) may try multiple receive configurations (for example, directional listening) when receiving various signals from the BS 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (for example, different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some implementations, a receiving device may use a single receive configuration to receive along a single beam direction (for example, when receiving a data signal). The single receive configuration may be aligned in a beam direction determined based on listening according to different receive configuration directions (for example, a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer also may use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a BS 105 or a core network 130 supporting radio bearers for user plane data. At the physical layer, transport channels may be mapped to physical channels.

In some systems, such as the wireless communications system 100, one or more components of one or more BSs 105 may transmit one or more reference signals via various directional beams. A UE 115 may measure the reference signals sent from the one or more BSs 105 or cells via the various directional beams. In some examples, the one or more BSs 105 or cells from which the UE 115 may receive and measure reference signals may include one or more non-serving cells. Such one or more non-serving cells may refer to any one or more network entities from which the UE 115 does not expect to receive control signaling, scheduling information, activation messages, or the like. Instead, the UE 115 may expect to receive such signaling from a serving cell or BS 105.

In some examples, the UE 115 may support L1- or L2-centric inter-cell mobility and inter-cell mTRP communication and may monitor over a set of beam measurement resources to measure the reference signals sent from the one or more non-serving cells. In some implementations, the UE 115 may transmit a request (such as to a serving BS 105) for resources over which to transmit a beam report for at least one of the one or more non-serving cells if the non-serving cell beam measurements obtained by the UE 115 satisfy a condition. As described herein, such a beam report for at least one non-serving cell may be equivalently referred to as a non-serving cell beam report and such a request for the resources over which to transmit the non-serving cell beam report may be referred to as a resource request (as the request may function as or be similar to a request for resources).

In response to transmitting the request for the resources over which to transmit the non-serving cell beam report, the UE 115 may receive (from the serving BS 105) a request or a scheduling grant for the non-serving cell beam report. The request for the non-serving cell beam report may be, or include, or be otherwise associated with an indication or a scheduling grant of resources over which the UE 115 is to transmit the non-serving cell beam report (as requested by the UE 115) and, in some examples, may indicate a content to be included in the non-serving cell beam report. The UE 115 may transmit the non-serving cell beam report over the indicated resources and in accordance with the requested content.

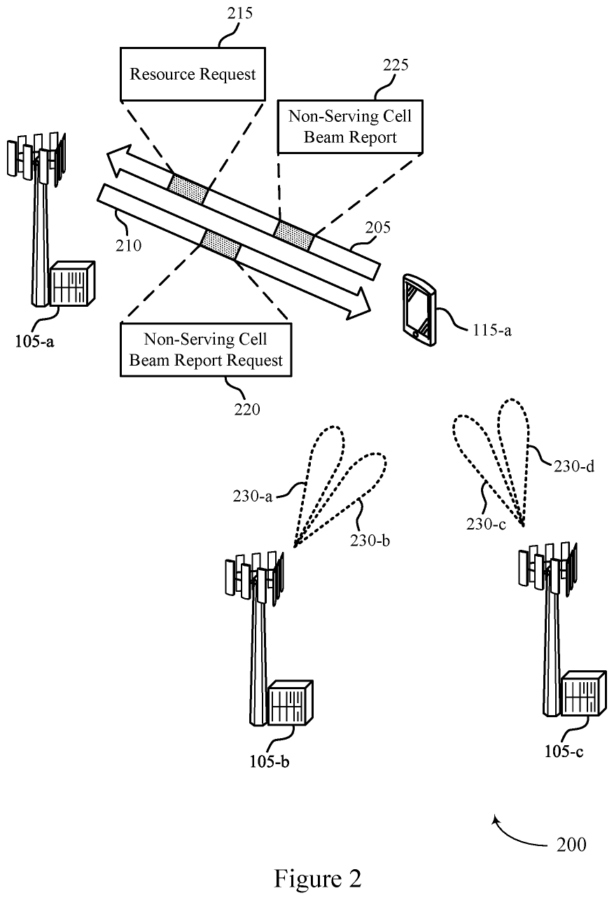

FIG. 2 illustrates an example signaling diagram 200 that supports techniques for transmitting an event-triggered non-serving cell beam report. The signaling diagram 200 may implement or be implemented to realize aspects of the wireless communications system 100. For example, the signaling diagram 200 may include a UE 115-a, a BS 105-a, a BS 105-b, and a BS 105-c, which may be examples of corresponding devices described herein, including with reference to FIG. 1. In some examples, the UE 115-a may transmit, to one or more components of the BS 105-a, a resource request 215 for resources over which to transmit a non-serving cell beam report 225 as a result of a signal quality associated with a set of beams 230 associated with one or more non-serving cells (such as one or both of the BS 105-b and the BS 105-c) satisfying a condition.

For example, the UE 115-a may support a reference signal receive power (RSRP) multi-beam measurement (such as an L1-RSRP multi-beam measurement) and reporting mechanism for one or both of L1/L2-centric inter-cell mobility or inter-cell mTRP. In such examples, the UE 115-a may support a lower limit or minimum number of beams 230 associated with one or more non-serving cells (such as one or both of the BS 105-b and the BS 105-c) that are reported in a single CSI reporting instance. In other words, for a given CSI reporting instance, the UE 115-a may measure a channel quality and be capable of reporting the measured channel quality for at least K beams 230 that are associated with at least one non-serving cell (such as at least one of the BS 105-b or the BS 105-c). A CSI reporting configuration may configure the UE 115-a to measure beam quality on different reference signals, such as CSI-RSs or synchronization signal blocks (SSBs), and these reference signals may have different physical cell identities. In some examples, a value of K may be configured by the network (such as by the BS 105-a) in accordance with a UE capability. For example, the UE 115-a may be capable of measuring a number of beams 230 that are associated with one or more non-serving cells, may transmit an indication of the capability to one or more components of the BS 105-a, and the BS 105-a may configure K such that K is less than or equal to the capability of the UE 115-a. For purpose of example, K may equal to 4, 8, 16, or any other number. In some examples, however, if K>4, an upper limit or maximum number of beams 230 associated with one non-serving cell may be equal to 4.

In some examples, the UE 115-a may report a CSI report for a candidate maximum permissible exposure (MPE) measurement. The UE 115-a may report a number of K resource indices (such as indices for one or more reference signals, such as SSB or CSI-RS resources), and a number of K modified virtual power headroom reports (PHR) in a CSI report instance. The value of K may be configured in the RRC signaling for the CSI report configuration, such as “CSI-reportConfig.” The UE 115-a may report its UE capability for the maximum value of K. The modified virtual PHRs and the resource indices in the CSI report may be one-to-one mapped, where the modified virtual PHRs may be for a Type 1 or a Type 3 PHR report. If reporting a modified virtual PHR, the UE 115-a may take into account the allowed maximum output power reduction (such as Power Management Power reduction (P-MPR)) based on MPE impact for selecting or determining the available maximum transmit power Pcmax, where the P-MPR value may be specific to the mapped SSB or CSI-RS resource.

If the UE 115-a reports a modified virtual PHR based on a pathloss reference signal (PLRS), the pathloss to be calculated in the modified virtual PHR may be based on the L1-RSRP value measured from the mapped SSB/CSI-RS, where the L1-RSRP value may be measured with at least once. The reference signal resource configured for the measurement of the CSI report may be a source reference signal in a configured or activated transmission configuration indicator (TCI), or may be a reference signal with a configured or activated TCI. In some examples, if the UE 115-a reports a modified virtual PHR based on a PLRS for a reference signal, the PLRS may be the PLRS associated with the corresponding TCI for the reference signal. The UE 115-a may also report a UE capability on the maximum number of activated TCIs for a candidate MPE measurement in a CSI report. The CSI report may be configured as aperiodic CSI report, or semi-persistent CSI report, or periodic CSI report, and the CSI report may be carried either in PUCCH or PUSCH. In some examples, the CSI report may be scheduled by a network entity, such as a BS 105, or may be event triggered from the UE 115-a. If the CSI report is event triggered by the UE 115-a, the UE may transmit a physical random access channel (PRACH) procedure message if the maximum transmit power Pcmax is reached.

In some examples, the UE 115-a may receive an indication or may be otherwise configured with a set of resources over which to measure a set of beams 230 associated with one or more non-serving cells (such as one or both of the BS 105-b and the BS 105-c) and may measure the set of beams over the indicated or configured set of resources. In some systems, the UE 115-a may report the non-serving cell beam measurements as a result of (and exclusively as a result of) receiving a request for a non-serving cell beam report from one or more components of the BS 105-a. In such systems, however, the UE 115-a may be unable to report non-serving cell beam measurements without receiving the request from the BS 105-a, which may result in a rigid and inflexible reporting mechanism. For example, even though the UE 115-a may obtain non-serving cell beam measurements that may potentially result in UE mobility or a change in a measurement configuration at the UE 115-a, the UE 115-a may be unable to report such non-serving cell beam measurements until requested by the BS 105-a. As such, the UE 115-a may be unable to dynamically or flexibly provide information that may potentially result in a system change or a change in a communication environment of the UE 115-a (UE mobility or a change in a measurement configuration at the UE 115-a), which may result in the UE 115-a being stuck with one or more radio connections that may not provide a greatest robustness, reliability, or coverage relative to other potential radio connections.

Accordingly, in some implementations, the UE 115-a may employ or otherwise support an L1-based event-driven reporting of non-serving cell beam measurements according to which the UE 115-a may more dynamically and flexibly provide non-serving cell beam measurements to the BS 105-a, which may result in a more timely exchange of beam quality information and potentially in more dynamic or flexible UE mobility procedures or measurement configurations. In some examples, the set of beam measurement resources over which the UE 115-a may monitor to measure the set of beams 230 may be configured to be associated with the one or more non-serving cells. For example, one or more components of the BS 105-a may transmit an indication of the set of beam measurement resources to the UE 115-a and may indicate that the set of beam measurement resources are configured for beam measurements of non-serving cells, such as for beam measurements of the BS 105-b or the BS 105-c.

In such examples, the set of beams 230 may include one or more of a beam 230-a and a beam 230-b from the BS 105-b (which may be an example of a first non-serving cell) or one or more of a beam 230-c and a beam 230-d from the BS 105-c (which may be an example of a second non-serving cell), or any combination thereof. As such, the UE 115-a may measure the set of beams 230 (such as measure a beam quality or a signal strength of one or more reference signals sent via each beam 230 of the set of beams 230) and may transmit a resource request 215 via a communication link 205 requesting resources over which the UE 115-a may transmit a non-serving cell beam report 225 for at least one non-serving cell if one or more conditions or events are met.

In some implementations, for example, the UE 115-a may transmit the resource request 215 if each beam 230 of the set of beams 230 that are associated with the one or more non-serving cells has a beam quality that fails to satisfy a quality threshold. In other words, for example, the UE 115-a may transmit the resource request 215 if each beam 230 in the set of beams 230 has a beam quality worse than (such as lower than) a quality threshold. In such examples in which the UE 115-a measures each beam 230 of the set of beams 230 to have a beam quality that fails to satisfy a quality threshold, the UE 115-a may transmit the resource request 215 (and, ultimately, the non-serving cell beam report 225) as part of a non-serving cell BFR procedure or as part of a deactivation of cell measurement, or both.

Additionally, or alternatively, the UE 115-a may transmit the resource request 215 if an average beam quality of the set of beams 230 that are associated with the one or more non-serving cells fails to satisfy a quality threshold. In other words, for example, the UE 115-a may measure, calculate, or otherwise determine an average beam quality of the set of beams 230 and may transmit the resource request 215 if the average beam quality is worse than (such as lower than) a quality threshold. In such examples in which the UE 115-a measures or calculates an average beam quality of the set of beams 230 that fails to satisfy a quality threshold, the UE 115-a may transmit the resource request 215 (and, ultimately, the non-serving cell beam report 225) as part of a cell-specific BFR. For example, if the set of beams 230 are associated with one non-serving cell and the average beam quality fails to satisfy a quality threshold, the UE 115-a may trigger a cell-specific BFR for that one non-serving cell via the resource request 215.

In some other implementations, the UE 115-a may transmit the resource request 215 if an average beam quality of the set of beams 230 that are associated with the one or more non-serving cells satisfies a quality threshold. In other words, for example, the UE 115-a may measure, calculate, or otherwise determine an average beam quality of the set of beams 230 and may transmit the resource request 215 if the average beam quality is better than (such as greater than) a quality threshold. In such examples in which the UE 115-a measures or calculates an average beam quality of the set of beams 230 that satisfies a quality threshold, the UE 115-a may transmit the resource request 215 (and, ultimately, the non-serving cell beam report 225) as part of a selection or an activation of a new cell measurement. For example, if the set of beams 230 are associated with one non-serving cell and the average beam quality satisfies a quality threshold, the UE 115-a may trigger a configuration or a new cell measurement for that one non-serving cell via the resource request 215.

Additionally, or alternatively, the UE 115-a may transmit the resource request 215 if an average beam quality of the set of beams 230 that are associated with the one or more non-serving cells changes a threshold amount relative to an average beam quality of a previous (such as a last or most recent) beam reporting or measurement. In other words, for example, the UE 115-a may measure, calculate, or otherwise determine a current average beam quality of the set of beams 230, may compare the current average beam quality to a previously reported or measured average beam quality (for the same set of beams), and may transmit the resource request 215 if the current average beam quality has changed more than a threshold delta from the previous average beam quality. In such examples in which the UE 115-a measures or calculates that a current average beam quality is different from a previous average beam quality for the same set of beams 230 by a threshold amount, the UE 115-a may transmit the resource request 215 (and, ultimately, the non-serving cell beam report 225) as part of a status update of non-serving cell measurement.

The UE 115-a may obtain and use any metric associated with beam quality for selecting or determining whether to request resources for the non-serving cell beam report 225. For example, the UE 115-a may use an L1-RSRP metric, an L3-RSRP metric, a signal-to-noise ratio (SNR), an interference metric, or any other metric associated with beam quality for selecting or determining whether to request resources for the non-serving cell beam report 225. Accordingly, the condition, event, threshold, or quality threshold that the UE 115-a may use for making non-serving cell beam reporting decisions may be a condition or event associated with any beam metric.

The UE 115-a may transmit the resource request 215 via various uplink signaling. In some implementations, the UE 115-a may transmit the resource request 215 via a dedicated scheduling request (such as a dedicated L1-based scheduling request). Such a dedicated scheduling request may include a scheduling request-physical uplink control channel (SR-PUCCH), such as a scheduling request PUCCH configured for a beam failure recovery purpose. Additionally, or alternatively, the UE 115-a may transmit the resource request 215 via dedicated MAC-CE signaling (such as via a dedicated MAC-CE). Further, the UE 115-a may, in some examples, indicate a configuration ID for the non-serving cell beam report 225 in the resource request 215. For example, the UE 115-a may select or otherwise identify a configuration or format of the non-serving cell beam report 215 (in accordance with the specific condition that is met or otherwise in accordance with the non-serving cell beam measurements that the UE 115-a requests to report) and may indicate the selected or identified configuration or format to the BS 105-a via the configuration ID in the resource request 215.

As such, the BS 105-a may obtain knowledge or awareness of the indicated configuration or format using the configuration ID and may construct or format a non-serving cell beam report request 220 accordingly. For example, one or more components of the BS 105-a may indicate a configuration, format, or content to be included in the non-serving cell beam report 225 via the non-serving cell beam report request 220 in accordance with the configuration ID provided by the UE 115-a via the resource request 215. One or more components of the BS 105-a may transmit the non-serving cell beam report request 220 to the UE 115-a via a communication link 210 responsive to the resource request 215. For example, the non-serving cell beam report request 220 may request the non-serving cell beam report 225 from the UE 115-a and may allocate or otherwise indicate a resource (or a set of resources) over which the UE 115-a is to transmit the non-serving cell beam report 225 to the BS 105-a.

The UE 115-a, as a result of receiving the non-serving cell beam report request 220, may generate or construct the non-serving cell beam report 225 in accordance with the requested configuration of the non-serving cell beam report 225. In some implementations, the UE 115-a may include a beam index for each beam 230 that is reported via the non-serving cell beam report 225 and, for each reported beam 230, may provide a measured beam quality. For example, the UE 115-a may include a CSI resource index or an SSB index, a serving cell index, a physical cell ID (PCI), or any combination thereof within the non-serving cell beam report 225 and may report the measured beam quality for each indicated beam via a beam quality metric (such as an L1-RSRP metric or a Layer 3 (L3)-RSRP metric). Further, in some implementations, the UE 115-a may report, via the non-serving cell beam report 225, beams 230 having largest RSRPs relative to other measured beams 230 (similar to CSI reporting of serving cell beams) regardless of what condition triggers the non-serving cell beam report 225.

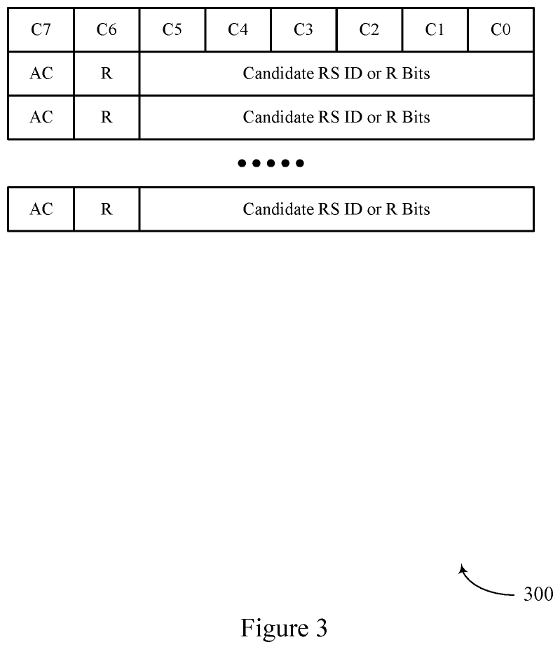

The UE 115-a may transmit the non-serving cell beam report 225 to the BS 105-a via various types of uplink signaling. In some implementations, the UE 115-a may transmit the non-serving cell beam report 225 to the BS 105-a via a MAC-CE. Such implementations in which the UE 115-a transmits the non-serving cell beam report 225 via a MAC-CE may include examples in which the UE 115-a extends a MAC-CE configured for secondary cell (SCell) BFR to additionally report information at least for the one or more non-serving cells, as illustrated by and described in more detail with reference to FIG. 3. For example, the described L1-based event-driven reporting mechanism may build off of an SCell BFR framework.

Additionally, or alternatively, the UE 115-a may transmit the non-serving cell beam report 225 to the BS 105-a via uplink control information (UCI). Additionally, or alternatively, the UE 115-a may transmit the non-serving cell beam report 225 to the BS 105-a via an L3 measurement report. For example, the described L1-based event-driven reporting mechanism may be similar to an L3-based event-driven reporting mechanism but with L1-based events and with a definition for such L1-based events.

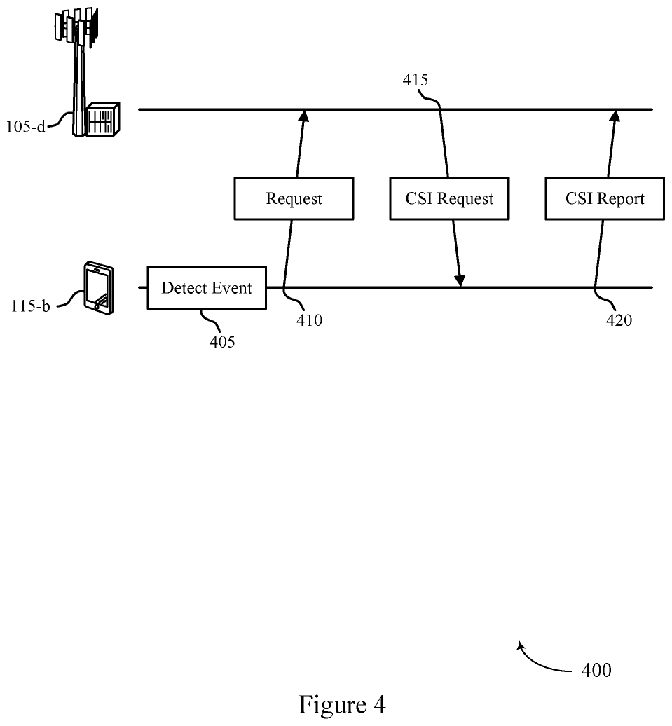

In some implementations, the UE 115-a may start a timer to prohibit a transmission of another resource request 215 or another non-serving cell beam report 225 for a duration of time. In some examples, for instance, the UE 115-a may start a timer as a result of transmitting the resource request 215 and may refrain from transmitting another resource request 215 for a duration of the timer (such as until the timer expires). Similarly, in some examples, the UE 115-a may start a timer as a result of transmitting the non-serving cell beam report 225 and may refrain from transmitting another non-serving cell beam report 225 for a duration of the timer (such as until the timer expires). Further, although described in the context of the resource request 215 and the non-serving cell beam report 225, the UE 115-a also may start a timer as a result of receiving the non-serving cell beam report request 220 and may refrain from expecting to receive another non-serving cell beam report request 220 for a duration of the timer (such as until the timer expires). Further, the non-serving cell beam report request 220 may be equivalently referred to or understood as a CSI request and the non-serving cell beam report 225 may be equivalently referred to or understood as a CSI report, as described in more detail with reference to FIG. 4.

FIG. 3 illustrates an example control element 300 that supports techniques for transmitting an event-triggered non-serving cell beam report. The control element 300 may implement or be implemented to realize aspects of the wireless communications system 100 or the signaling diagram 200. For example, a UE 115 may transmit the control element 300 to a BS 105 (or to one or more components of the BS 105) to report beam measurement information associated with one or more non-serving cells as a result of non-serving cell beam measurements at the UE 115 satisfying a condition or event (such as an L1-based condition or event). Such a UE 115 and a BS 105 may be examples of corresponding devices described herein, including with reference to FIGS. 1 and 2.

The control element 300 may include a quantity of C bits (such as 8 C bits, illustrated in FIG. 3 by Cₙ, where n={0, 1, 2, 3, 4, 5, 6, 7} where each different C bit indicates a different component carrier (CC) of a different SCell), a quantity of AC bits, a quantity of reserved bits R, and a quantity of fields that may be usable by the UE 115 to indicate a candidate reference signal ID or for additional reserved bits R. In some examples, the UE 115 may set a CL bit to either 0 or 1 and may indicate, via the CL bit, that a BFR failure is detected in the cell index (the cell index corresponding to CL) in accordance with a configuration and that the cell index may have a different PCI than the serving cell. The UE 115 may similarly set an AC bit to 0 or 1 and may indicate, via the AC bit, whether there is a new beam information reference signal (NBI-RS). In some examples, the UE 115 may include a candidate reference signal ID (instead of including additional reserved bits R) if a corresponding AC bit is set to 1.

In some implementations, the UE 115 may extend a MAC-CE for SCell BFR to report beam information for at least one or more non-serving cells as a result of non-serving cell beam measurements at the UE 115 satisfying the condition or event, as described in more detail with reference to FIG. 2, and the control element 300 may be an example of such an extended MAC-CE for SCell BFR that is usable to convey beam information for the at least one or more non-serving cells. For example, the UE 115 may construct or format the MAC-CE to extend a CC index field to provide sufficient resources to indicate a CC index of a different PCI. In such examples, the UE 115 may order the C bits in accordance with PCI first and CC ID second. As such, for example, C₀ may be a PCell and correspond to a CC0 of a PCI0, C₁ may be a PCell and correspond to a CC0 of a PCI1, C₂ may be an SCell and correspond to a CC1, and so on.

FIG. 4 illustrates an example communication timeline 500 that supports techniques for transmitting an event-triggered non-serving cell beam report. The communication timeline 400 may implement or be implemented to realize aspects of the wireless communications system 100 or the signaling diagram 200. For example, the communication timeline 400 illustrates communication between a UE 115-b and a BS 105-d, which may be examples of corresponding devices described herein, including with reference to FIGS. 1 and 2. In some examples, the UE 115-b may transmit a request for resources over which to transmit a non-serving cell beam report as a result of non-serving cell beam measurements at the UE 115-b satisfying a triggering condition or event.

At 405, the UE 115-b may detect an event that triggers a UE-initiated non-serving cell beam report. In some examples, the event may refer to an L1-based event and may be associated with beam measurements for a set of beams that are associated with one or more non-serving cells. For example, the UE 115-b may detect the event at 405 if each beam of the set of beams is associated with a beam quality that fails to satisfy a quality threshold, if an average beam quality of the set of beams fails to satisfy a quality threshold, if an average beam quality of the set of beams satisfies a quality threshold, or if an average beam quality of the set of beams changes more than a threshold amount relative to a previously reported or measured average beam quality of the set of beams. Additional details relating to such events that trigger the transmission of the resource request from the UE 115-b are described herein, including with reference to FIG. 2.

At 410, the UE 115-b may transmit, to one or more components of the BS 105-d, a request for resources over which to transmit a CSI report including a non-serving cell beam report as a result of detecting the event at 405. Such a request for resources may be referred to herein as a resource request and the UE 115-b may transmit the request via a scheduling request or a MAC-CE.

At 415, the BS 105-d may transmit a CSI request to the UE 115-b requesting the CSI report including the non-serving cell beam report as a result of receiving the request at 410. For example, the request may trigger the CSI request from the BS 105-d. In some examples, the CSI request may indicate resources over which the UE 115-b is to transmit the CSI report including the non-serving cell beam report and may indicate a format or content for the CSI report.

At 420, the UE 115-b may transmit, to one or more components of the BS 105-d, the CSI report including the non-serving cell beam report. In some examples, the UE 115-b may generate the CSI report in accordance with the format or content indicated by the CSI request and may transmit the CSI report over the resources indicated by the CSI request.

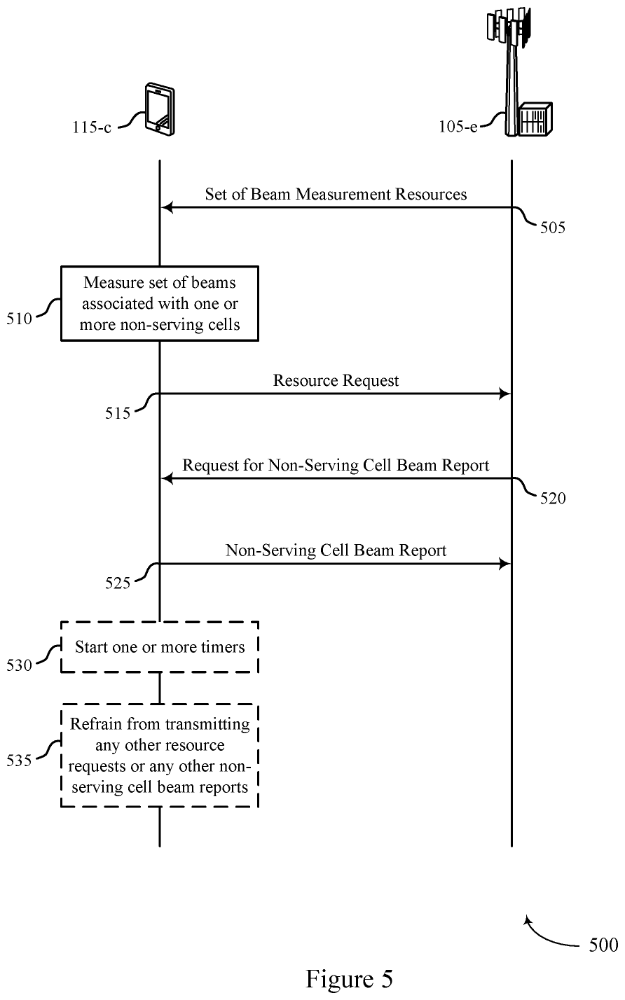

FIG. 5 illustrates an example process flow 500 that supports techniques for transmitting an event-triggered non-serving cell beam report. The process flow 500 may implement or be implemented to realize aspects of the wireless communications system 100 or the signaling diagram 200. For example, the process flow 500 illustrates communication between a UE 115-c and one or more components of a BS 105-e, which may be examples of corresponding devices described herein, including with reference to FIGS. 1 and 2. In some examples, the UE 115-c may transmit a request for resources over which to transmit a non-serving cell beam report as a result of non-serving cell beam measurements at the UE 115-c satisfying a triggering condition or event.

In the following description of the process flow 500, the operations may be performed (such as reported or provided) in a different order than the order shown, or the operations performed by the example devices may be performed in different orders or at different times. Some operations also may be left out of the process flow 500, or other operations may be added to the process flow 500. Further, although some operations or signaling may be shown to occur at different times for discussion purposes, these operations may actually occur at the same time.

At 505, the UE 115-c may receive an indication of a set of beam measurement resources over which the UE 115-c is to measure a set of beams associated with one or more non-serving cells. In some examples, the UE 115-c may receive the indication from the BS 105-e and the BS 105-e may configure the set of beam measurement resources such that the beam measurement resources are associated with (or configured for) non-serving cell beam measurement opportunities.

At 510, the UE 115-c may measure the set of beams associated with the one or more non-serving cells over the set of beam measurement resources. For example, the UE 115-c may monitor over the set of beam measurement resources and measure one or more reference signals transmitted by the one or more non-serving cells as a result of monitoring over the set of beam measurement resources. In some examples, the one or more non-serving cells may transmit such one or more reference signals via different beams of the set of beams for which the UE 115-c reports.

At 515, the UE 115-c may transmit a resource request associated with a non-serving cell beam report. In some examples, the UE 115-c may transmit the resource request to the BS 105-e (a serving cell) to request resources over which the UE 115-c may transmit the non-serving cell beam report and as a result of the set of beams satisfying a condition. For example, the UE 115-c may transmit the resource request if each beam of the set of beams is associated with a beam quality that fails to satisfy a quality threshold, if an average beam quality of the set of beams fails to satisfy a quality threshold, if an average beam quality of the set of beams satisfies a quality threshold, or if an average beam quality of the set of beams changes more than a threshold amount relative to a previously reported or measured average beam quality of the set of beams. Additional details relating to such conditions or events that trigger the transmission of the resource request from the UE 115-c are described herein, including with reference to FIG. 2.

At 520, the UE 115-c may receive, responsive to the resource request, a request for the non-serving cell beam report. In some examples, the UE 115-c may receive the request for the non-serving cell beam report from the BS 105-e and the non-serving cell beam report may indicate a resource (or a set of resources) over which the UE 115-c may transmit the non-serving cell beam report and a content to be included in the non-serving cell beam report. In some implementations, the BS 105-e may request a content to be included in the non-serving cell beam report in accordance with a configuration ID provided by the UE 115-c via the resource request sent at 515.

At 525, the UE 115-c may transmit the non-serving cell beam report in accordance with the request for the non-serving cell beam report. In some examples, the non-serving cell beam report may convey beam quality information for the set of beams associated with the one or more non-serving cells. In some implementations, the UE 115-c may transmit the non-serving cell beam report to the BS 105-e over the resource (or set of resources) and according to the requested content indicated by the request for the non-serving cell beam report received at 520.

At 530, the UE 115-c may start one or more timers. In some examples, such one or more timers may be referred to herein as prohibit-timers and the UE 115-c may refrain from transmitting specific types of signaling for a duration of such prohibit-timers. In some implementations, for example, the UE 115-c may start a first timer (a first prohibit-timer) as a result of transmitting the resource request at 515. Additionally, or alternatively, the UE 115-c may start a second timer (a second prohibit-timer) as a result of transmitting the non-serving cell beam report at 525. As such, although FIG. 4 shows the UE 115-c starting the one or more timers at a same time, the UE 115-c may start the first timer and the second timer at different times as a result of transmitting the resource request and the non-serving cell beam report at different times.

At 535, the UE 115-c may refrain from transmitting any other resource requests or any other non-serving cell beam reports for a duration of the one or more timers. In some implementations, for example, the UE 115-c may refrain from transmitting any other resource requests associated with non-serving cell beam reports for a duration of the first timer. Additionally, or alternatively, the UE 115-c may refrain from transmitting any other non-serving cell beam reports for a duration of the second timer. Further, although described herein as using two separate prohibit-timers for other resource requests and other non-serving cell beam reports, the UE 115-c may alternatively use one prohibit-timer for both resource requests and other non-serving cell beam reports without exceeding the scope of the present disclosure. For example, the UE 115-c may start one timer as a result of either transmitting the resource request at 515 or as a result of transmitting the non-serving cell beam report at 525 and may refrain from transmitting any other resource requests or any other non-serving cell beam reports for a duration of the one timer.

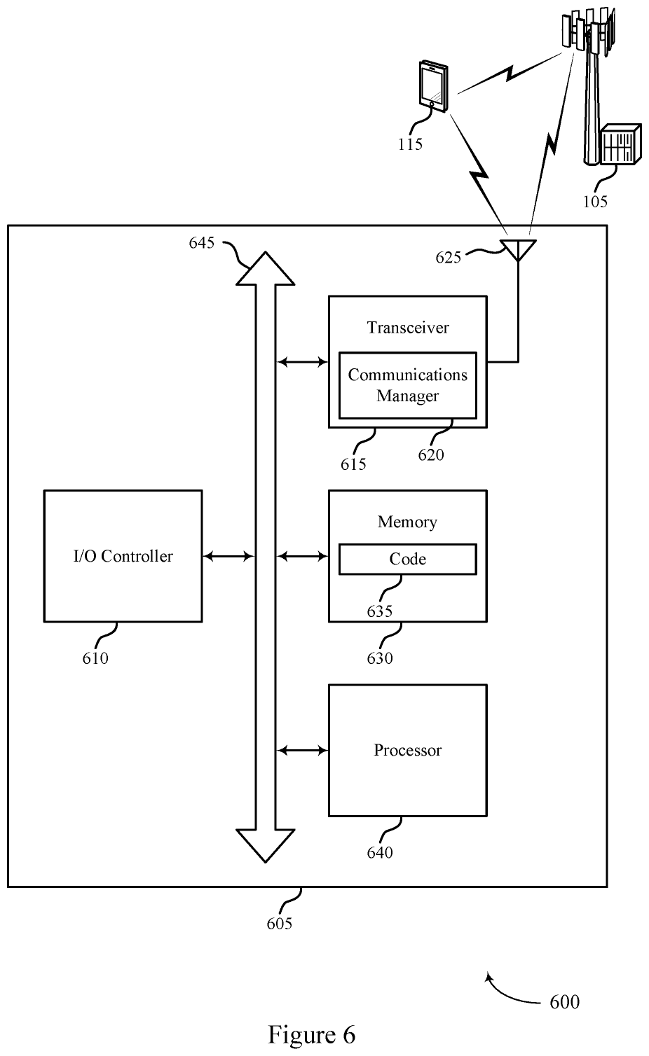

FIG. 6 shows a block diagram 600 of an example device 605 that supports techniques for transmitting an event-triggered non-serving cell beam report. The device 605 may communicate wirelessly with one or more BSs 105, UEs 115, or any combination thereof. The device 605 may include components for bi-directional voice and data communications including components for transmitting and receiving communications, such as a communications manager 620, an input/output (I/O) controller 610, a transceiver 615, an antenna 625, a memory 630, code 635, and a processor 640. These components may be in electronic communication or otherwise coupled (such as operatively, communicatively, functionally, electronically, electrically) via one or more buses (such as a bus 645).

The I/O controller 610 may manage input and output signals for the device 605. The I/O controller 610 also may manage peripherals not integrated into the device 605. In some implementations, the I/O controller 610 may represent a physical connection or port to an external peripheral. In some implementations, the I/O controller 610 may utilize an operating system such as iOS®, ANDROID®, MS-DOS®, MS-WINDOWS®, OS/2®, UNIX®, LINUX®, or another known operating system. Additionally, or alternatively, the I/O controller 610 may represent or interact with a modem, a keyboard, a mouse, a touchscreen, or a similar device. In some implementations, the I/O controller 610 may be implemented as part of a processor or processing system, such as the processor 640. In some implementations, a user may interact with the device 605 via the I/O controller 610 or via hardware components controlled by the I/O controller 610.

In some implementations, the device 605 may include a single antenna 625. However, in some other implementations, the device 605 may have more than one antenna 625, which may be capable of concurrently transmitting or receiving multiple wireless transmissions. The transceiver 615 may communicate bi-directionally, via the one or more antennas 625, wired, or wireless links as described herein. For example, the transceiver 615 may represent a wireless transceiver and may communicate bi-directionally with another wireless transceiver. The transceiver 615 also may include a modem to modulate the packets, to provide the modulated packets to one or more antennas 625 for transmission, and to demodulate packets received from the one or more antennas 625.

In some implementations, the transceiver 615 may include one or more interfaces, such as one or more interfaces coupled with the one or more antennas 625 that are configured to support various receiving or obtaining operations, or one or more interfaces coupled with the one or more antennas 625 that are configured to support various transmitting or outputting operations, or a combination thereof. In some implementations, the transceiver 615 may include or be configured for coupling with one or more processors or memory components that are operable to perform or support operations based on received or obtained information or signals, or to generate information or other signals for transmission or other outputting, or any combination thereof. In some implementations, the transceiver 615, or the transceiver 615 and the one or more antennas 625, or the transceiver 615 and the one or more antennas 625 and one or more processors or memory components (for example, the processor 640, or the memory 630, or both), may be included in a chip or chip assembly that is installed in the device 605.

The memory 630 may include random access memory (RAM) and read-only memory (ROM). The memory 630 may store computer-readable, computer-executable code 635 including instructions that, when executed by the processor 640, cause the device 605 to perform various functions described herein. The code 635 may be stored in a non-transitory computer-readable medium such as system memory or another type of memory. In some implementations, the code 635 may not be directly executable by the processor 640 but may cause a computer (for example, when compiled and executed) to perform functions described herein. In some implementations, the memory 630 may contain, among other things, a basic I/O system (BIOS) which may control basic hardware or software operation such as the interaction with peripheral components or devices.

The processor 640 may be any one or more suitable processors capable of executing scripts or instructions of one or more software programs stored in the device 605 (such as within the memory 630). In some implementations, the processor 640 may be a component of a processing system. A processing system may generally refer to a system or series of machines or components that receives inputs and processes the inputs to produce a set of outputs (which may be passed to other systems or components of, for example, the device 605). For example, a processing system of the device 605 may refer to a system including the various other components or subcomponents of the device 605, such as the processor 640, or the transceiver 615, or the communications manager 620, or other components or combinations of components of the device 605.

The processing system of the device 605 may interface with other components of the device 605, and may process information received from other components (such as inputs or signals) or output information to other components. For example, a chip or modem of the device 605 may include a processing system, a first interface to output information, and a second interface to obtain information. In some implementations, the first interface may refer to an interface between the processing system of the chip or modem and a transmitter, such that the device 605 may transmit information output from the chip or modem. In some implementations, the second interface may refer to an interface between the processing system of the chip or modem and a receiver, such that the device 605 may obtain information or signal inputs, and the information may be passed to the processing system. A person having ordinary skill in the art will readily recognize that the first interface also may obtain information or signal inputs, and the second interface also may output information or signal outputs.

The communications manager 620 may support wireless communication at a UE in accordance with examples as disclosed herein. For example, the communications manager 620 may be configured as or otherwise support a means for transmitting a resource request associated with a non-serving cell beam report. The communications manager 620 may be configured as or otherwise support a means for receiving, responsive to the resource request, a request for the non-serving cell beam report. The communications manager 620 may be configured as or otherwise support a means for transmitting the non-serving cell beam report, where the non-serving cell beam report conveys beam quality information for a set of beams associated with one or more non-serving cells.

In some examples, to support transmitting the resource request associated with the non-serving cell beam report, the communications manager 620 may be configured as or otherwise support a means for transmitting an indication of a configuration identifier for the non-serving cell beam report.

In some examples, to support receiving the request for the non-serving cell beam report, the communications manager 620 may be configured as or otherwise support a means for receiving an indication of a set of resources over which the UE is to transmit the non-serving cell beam report, where the non-serving cell beam report is transmitted over the set of resources in accordance with the request for the non-serving cell beam report.

In some examples, receiving the request for the non-serving cell beam report includes receiving an indication of a content to be included in the non-serving cell beam report. In some examples, transmitting the non-serving cell beam report in accordance with the request includes transmitting a beam index for each beam of the set of beams and, for each beam of the set of beams, an RSRP measurement in accordance with the content indicated by the request for the non-serving cell beam report.

In some examples, the communications manager 620 may be configured as or otherwise support a means for starting a timer as a result of transmitting the resource request. In some examples, the communications manager 620 may be configured as or otherwise support a means for refraining from transmitting any other resource requests associated with non-serving cell beam reports for a duration of the timer.

In some examples, the communications manager 620 may be configured as or otherwise support a means for starting a timer as a result of transmitting the non-serving cell beam report. In some examples, the communications manager 620 may be configured as or otherwise support a means for refraining from transmitting any other non-serving cell beam reports for a duration of the timer.

In some examples, to support transmitting the non-serving cell beam report, the communications manager 620 may be configured as or otherwise support a means for transmitting an indication of the non-serving cell beam report via a number of bits in a BFR MAC-CE.

In some examples, the number of bits convey information related to one or more PCIs and, for each of the one or more PCIs, one or more component carrier indexes.

In some examples, the communications manager 620 may be configured as or otherwise support a means for receiving an indication of a set of beam measurement resources over which the UE is to measure the set of beams associated with the one or more non-serving cells. In some examples, the communications manager 620 may be configured as or otherwise support a means for measuring a reference signal corresponding to each of the set of beams associated with the one or more non-serving cells over the set of beam measurement resources.

In some examples, to support measuring the reference signal corresponding to each of the set of beams associated with the one or more non-serving cells, the communications manager 620 may be configured as or otherwise support a means for measuring that a respective beam quality of each beam of the set of beams fails to satisfy a quality threshold, where transmitting the resource request associated with the non-serving cell beam report is a result of the respective beam quality of each beam of the set of beams failing to satisfy the quality threshold.

In some examples, to support measuring the reference signal corresponding to each of the set of beams associated with the one or more non-serving cells, the communications manager 620 may be configured as or otherwise support a means for measuring that an average beam quality of the set of beams fails to satisfy a quality threshold, where transmitting the resource request associated with the non-serving cell beam report is a result of the average beam quality of the set of beams failing to satisfy the quality threshold.

In some examples, to support measuring the reference signal corresponding to each of the set of beams associated with the one or more non-serving cells, the communications manager 620 may be configured as or otherwise support a means for measuring that an average beam quality of the set of beams satisfies a quality threshold, where transmitting the resource request associated with the non-serving cell beam report is a result of the average beam quality of the set of beams satisfying the quality threshold.

In some examples, to support measuring the reference signal corresponding to each of the set of beams associated with the one or more non-serving cells, the communications manager 620 may be configured as or otherwise support a means for measuring that an average beam quality of the set of beams has changed greater than a threshold amount relative to a previous average beam quality of the set of beams obtained from a previous measurement, where transmitting the resource request associated with the non-serving cell beam report is a result of the average beam quality of the set of beams changing greater than the threshold amount relative to the previous average beam quality of the set of beams obtained from the previous measurement.

In some examples, the resource request associated with the non-serving cell beam report includes one or both of a scheduling request or a MAC-CE.

In some examples, the non-serving cell beam report is transmitted via a MAC-CE, UCI, an L3 measurement report, or any combination thereof.

In some implementations, the communications manager 620 may be configured to perform various operations (for example, receiving, monitoring, transmitting) using or otherwise in cooperation with the transceiver 615, the one or more antennas 625, or any combination thereof. Although the communications manager 620 is illustrated as a separate component, in some implementations, one or more functions described with reference to the communications manager 620 may be supported by or performed by the processor 640, the memory 630, the code 635, or any combination thereof. For example, the code 635 may include instructions executable by the processor 640 to cause the device 605 to perform various aspects of techniques for transmitting an event-triggered non-serving cell beam report as described herein, or the processor 640 and the memory 630 may be otherwise configured to perform or support such operations.

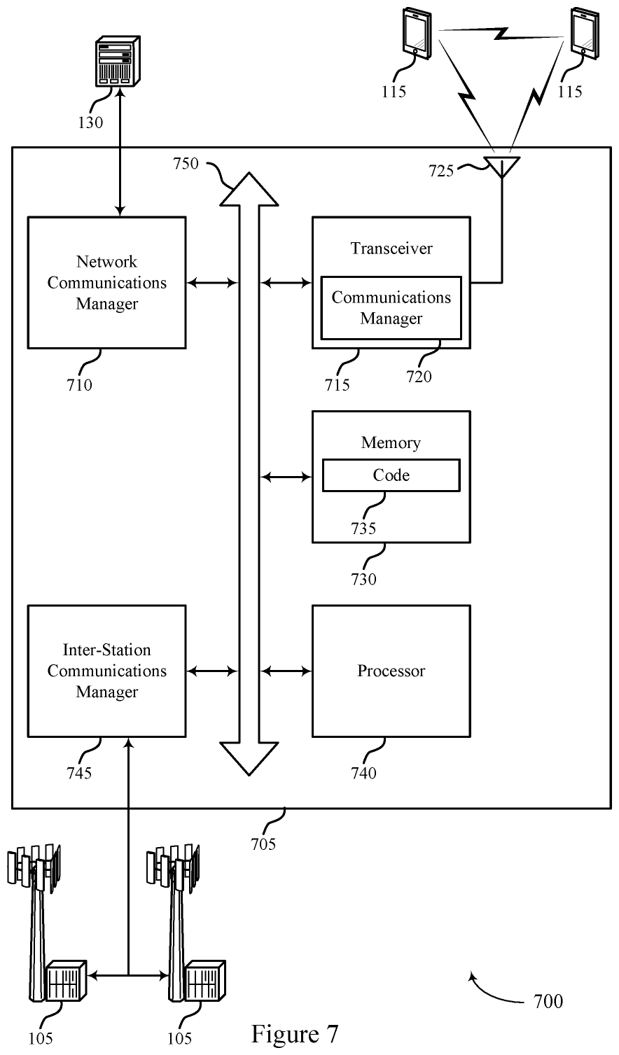

FIG. 7 shows a block diagram 700 of an example device 705 that supports techniques for transmitting an event-triggered non-serving cell beam report. The device 705 may communicate wirelessly with one or more BSs 105, UEs 115, or any combination thereof. The device 705 may include components for bi-directional voice and data communications including components for transmitting and receiving communications, such as a communications manager 720, a network communications manager 710, a transceiver 715, an antenna 725, a memory 730, code 735, a processor 740, and an inter-station communications manager 745. These components may be in electronic communication or otherwise coupled (such as operatively, communicatively, functionally, electronically, electrically) via one or more buses (such as a bus 750).

The network communications manager 710 may manage communications with a core network 130 (for example, via one or more wired backhaul links). For example, the network communications manager 710 may manage the transfer of data communications for client devices, such as one or more UEs 115.

In some implementations, the device 705 may include a single antenna 725. However, in some other implementations, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 also may include a modem to modulate the packets, to provide the modulated packets to one or more antennas 725 for transmission, and to demodulate packets received from the one or more antennas 725.

In some implementations, the transceiver 715 may include one or more interfaces, such as one or more interfaces coupled with the one or more antennas 725 that are configured to support various receiving or obtaining operations, or one or more interfaces coupled with the one or more antennas 725 that are configured to support various transmitting or outputting operations, or a combination thereof. In some implementations, the transceiver 715 may include or be configured for coupling with one or more processors or memory components that are operable to perform or support operations based on received or obtained information or signals, or to generate information or other signals for transmission or other outputting, or any combination thereof. In some implementations, the transceiver 715, or the transceiver 715 and the one or more antennas 725, or the transceiver 715 and the one or more antennas 725 and one or more processors or memory components (for example, the processor 740, or the memory 730, or both), may be included in a chip or chip assembly that is installed in the device 705.

The memory 730 may include RAM and ROM. The memory 730 may store computer-readable, computer-executable code 735 including instructions that, when executed by the processor 740, cause the device 705 to perform various functions described herein. The code 735 may be stored in a non-transitory computer-readable medium such as system memory or another type of memory. In some implementations, the code 735 may not be directly executable by the processor 740 but may cause a computer (for example, when compiled and executed) to perform functions described herein. In some implementations, the memory 730 may contain, among other things, a BIOS which may control basic hardware or software operation such as the interaction with peripheral components or devices.

The processor 740 may be any one or more suitable processors capable of executing scripts or instructions of one or more software programs stored in the device 705 (such as within the memory 730). In some implementations, the processor 740 may be a component of a processing system. A processing system may generally refer to a system or series of machines or components that receives inputs and processes the inputs to produce a set of outputs (which may be passed to other systems or components of, for example, the device 705). For example, a processing system of the device 705 may refer to a system including the various other components or subcomponents of the device 705, such as the processor 740, or the transceiver 715, or the communications manager 720, or other components or combinations of components of the device 705.

The processing system of the device 705 may interface with other components of the device 705, and may process information received from other components (such as inputs or signals) or output information to other components. For example, a chip or modem of the device 705 may include a processing system, a first interface to output information, and a second interface to obtain information. In some implementations, the first interface may refer to an interface between the processing system of the chip or modem and a transmitter, such that the device 705 may transmit information output from the chip or modem. In some implementations, the second interface may refer to an interface between the processing system of the chip or modem and a receiver, such that the device 705 may obtain information or signal inputs, and the information may be passed to the processing system. A person having ordinary skill in the art will readily recognize that the first interface also may obtain information or signal inputs, and the second interface also may output information or signal outputs.

The inter-station communications manager 745 may manage communications with other BSs 105, and may include a controller or scheduler for controlling communications with UEs 115 in cooperation with other BSs 105. For example, the inter-station communications manager 745 may coordinate scheduling for transmissions to UEs 115 for various interference mitigation techniques such as beamforming or joint transmission. In some implementations, the inter-station communications manager 745 may provide an X2 interface within an LTE/LTE-A wireless communications network technology to provide communication between BSs 105.

The communications manager 720 may support wireless communication at a network entity in accordance with examples as disclosed herein. For example, the communications manager 720 may be configured as or otherwise support a means for receiving, from a UE, a resource request associated with a non-serving cell beam report. The communications manager 720 may be configured as or otherwise support a means for transmitting, to the UE and responsive to the resource request, a request for the non-serving cell beam report. The communications manager 720 may be configured as or otherwise support a means for receiving, from the LE, the non-serving cell beam report, where the non-serving cell beam report conveys beam quality information for a set of beams associated with one or more non-serving cells.

In some examples, to support receiving the resource request associated with the non-serving cell beam report, the communications manager 720 may be configured as or otherwise support a means for receiving an indication of a configuration identifier for the non-serving cell beam report.

In some examples, to support transmitting the request for the non-serving cell beam report, the communications manager 720 may be configured as or otherwise support a means for transmitting an indication of a set of resources over which the UE is to transmit the non-serving cell beam report, where the non-serving cell beam report is received over the set of resources in accordance with the request for the non-serving cell beam report.

In some examples, transmitting the request for the non-serving cell beam report includes transmitting an indication of a content to be included in the non-serving cell beam report. In some examples, receiving the non-serving cell beam report in accordance with the request includes receiving a beam index for each beam of the set of beams and, for each beam of the set of beams, an RSRP measurement in accordance with the content indicated by the request for the non-serving cell beam report.

In some examples, to support receiving the non-serving cell beam report, the communications manager 720 may be configured as or otherwise support a means for receiving an indication of the non-serving cell beam report via a number of bits in a BFR MAC-CE.

In some examples, the number of bits convey information related to one or more PCIs and, for each of the one or more PCIs, one or more component carrier indexes.

In some examples, the communications manager 720 may be configured as or otherwise support a means for transmitting an indication of a set of beam measurement resources over which the UE is to measure the set of beams associated with the one or more non-serving cells, where receiving the resource request associated with the non-serving cell beam report is a result of transmitting the indication of the set of beam measurement resources.

In some examples, the non-serving cell beam report indicates that a respective beam quality of each beam of the set of beams fails to satisfy a quality threshold. In some examples, receiving the resource request associated with the non-serving cell beam report is a result of the respective beam quality of each beam of the set of beams failing to satisfy the quality threshold.

In some examples, the non-serving cell beam report indicates that an average beam quality of the set of beams fails to satisfy a quality threshold. In some examples, receiving the resource request associated with the non-serving cell beam report is a result of the average beam quality of the set of beams failing to satisfy the quality threshold.

In some examples, the non-serving cell beam report indicates that an average beam quality of the set of beams satisfies a quality threshold. In some examples, receiving the resource request associated with the non-serving cell beam report is a result of the average beam quality of the set of beams satisfying the quality threshold.

In some examples, the non-serving cell beam report indicates that an average beam quality of the set of beams has changed greater than a threshold amount relative to a previous average beam quality of the set of beams obtained from a previous measurement. In some examples, receiving the resource request associated with the non-serving cell beam report is a result of the average beam quality of the set of beams changing greater than the threshold amount relative to the previous average beam quality of the set of beams obtained from the previous measurement.

In some examples, the resource request associated with the non-serving cell beam report includes one or both of a scheduling request or a MAC-CE.

In some examples, the non-serving cell beam report is received via a MAC-CE, UCI, an L3 measurement report, or any combination thereof.

In some implementations, the communications manager 720 may be configured to perform various operations (for example, receiving, monitoring, transmitting) using or otherwise in cooperation with the transceiver 715, the one or more antennas 725, or any combination thereof. Although the communications manager 720 is illustrated as a separate component, in some implementations, one or more functions described with reference to the communications manager 720 may be supported by or performed by the processor 740, the memory 730, the code 735, or any combination thereof. For example, the code 735 may include instructions executable by the processor 740 to cause the device 705 to perform various aspects of techniques for transmitting an event-triggered non-serving cell beam report as described herein, or the processor 740 and the memory 730 may be otherwise configured to perform or support such operations.

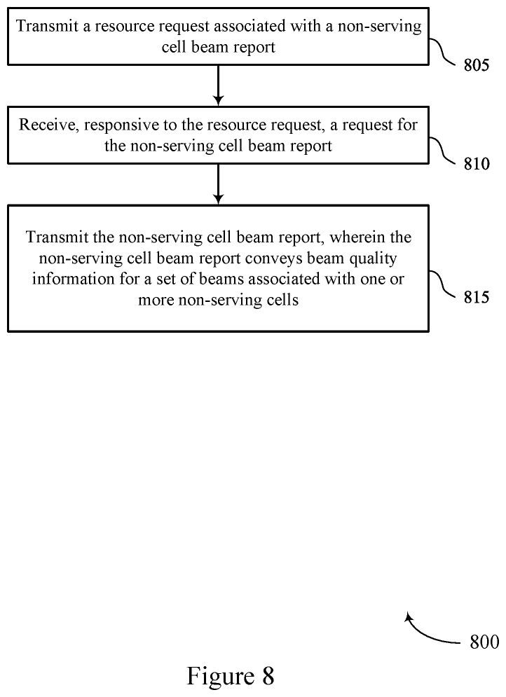

FIG. 8 shows a flowchart illustrating an example method 800 that supports techniques for transmitting an event-triggered non-serving cell beam report. The operations of the method 800 may be implemented by a UE or its components as described herein. For example, the operations of the method 800 may be performed by a UE 115 as described with reference to FIGS. 1-6. In some examples, a UE may execute a set of instructions to control the functional elements of the UE to perform the described functions. Additionally, or alternatively, the UE may perform aspects of the described functions using special-purpose hardware.

At 805, the method may include transmitting a resource request associated with a non-serving cell beam report. The operations of 805 may be performed in accordance with examples as disclosed herein. In some examples, aspects of the operations of 805 may be performed by a communications manager 520 as described with reference to FIG. 5.

At 810, the method may include receiving, responsive to the resource request, a request for the non-serving cell beam report. The operations of 810 may be performed in accordance with examples as disclosed herein. In some examples, aspects of the operations of 810 may be performed by a communications manager 520 as described with reference to FIG. 5.

At 815, the method may include transmitting the non-serving cell beam report, where the non-serving cell beam report conveys beam quality information for a set of beams associated with one or more non-serving cells. The operations of 815 may be performed in accordance with examples as disclosed herein. In some examples, aspects of the operations of 815 may be performed by a communications manager 520 as described with reference to FIG. 5.

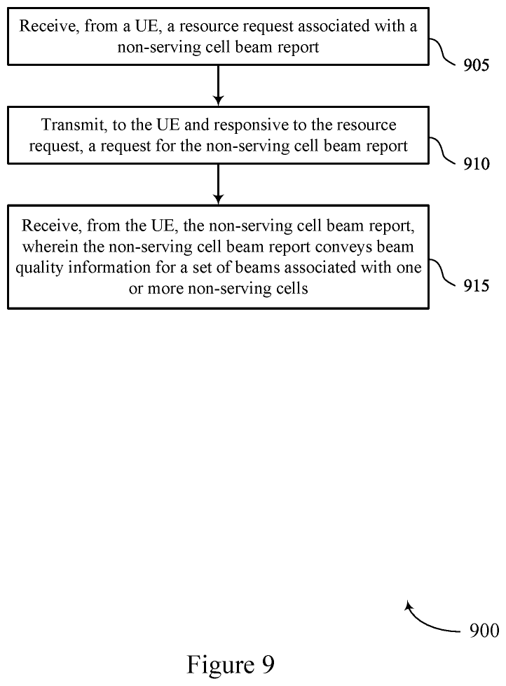

FIG. 9 shows a flowchart illustrating an example method 900 that supports techniques for transmitting an event-triggered non-serving cell beam report. The operations of the method 900 may be implemented by a BS or its components as described herein. For example, the operations of the method 900 may be performed by a BS 105 as described with reference to FIGS. 1-5 and 7. In some examples, a BS may execute a set of instructions to control the functional elements of the BS to perform the described functions. Additionally, or alternatively, the BS may perform aspects of the described functions using special-purpose hardware.

At 905, the method may include receiving, from a UE, a resource request associated with a non-serving cell beam report. The operations of 905 may be performed in accordance with examples as disclosed herein. In some examples, aspects of the operations of 905 may be performed by a communications manager 620 as described with reference to FIG. 6.

At 910, the method may include transmitting, to the UE and responsive to the resource request, a request for the non-serving cell beam report. The operations of 910 may be performed in accordance with examples as disclosed herein. In some examples, aspects of the operations of 910 may be performed by a communications manager 620 as described with reference to FIG. 6.

At 915, the method may include receiving, from the UE, the non-serving cell beam report, where the non-serving cell beam report conveys beam quality information for a set of beams associated with one or more non-serving cells. The operations of 915 may be performed in accordance with examples as disclosed herein. In some examples, aspects of the operations of 915 may be performed by a communications manager 620 as described with reference to FIG. 6.

The following provides an overview of some aspects of the present disclosure:

Aspect 1: A method for wireless communication at a UE, including: transmitting a resource request associated with a non-serving cell beam report; receiving, responsive to the resource request, a request for the non-serving cell beam report; and transmitting the non-serving cell beam report, where the non-serving cell beam report conveys beam quality information for a set of beams associated with one or more non-serving cells.

Aspect 2: The method of aspect 1, where transmitting the resource request associated with the non-serving cell beam report further includes: transmitting an indication of a configuration identifier for the non-serving cell beam report.

Aspect 3: The method of any of aspects 1 or 2, where receiving the request for the non-serving cell beam report includes: receiving an indication of a set of resources over which the UE is to transmit the non-serving cell beam report, where the non-serving cell beam report is transmitted over the set of resources in accordance with the request for the non-serving cell beam report.

Aspect 4: The method of any of aspects 1-3, where receiving the request for the non-serving cell beam report includes receiving an indication of a content to be included in the non-serving cell beam report; and transmitting the non-serving cell beam report in accordance with the request includes transmitting a beam index for each beam of the set of beams and, for each beam of the set of beams, an RSRP measurement in accordance with the content indicated by the request for the non-serving cell beam report.

Aspect 5: The method of any of aspects 1-4, further including: starting a timer as a result of transmitting the resource request; and refraining from transmitting any other resource requests associated with non-serving cell beam reports for a duration of the timer.

Aspect 6: The method of any of aspects 1-5, further including: starting a timer as a result of transmitting the non-serving cell beam report; and refraining from transmitting any other non-serving cell beam reports for a duration of the timer.

Aspect 7: The method of any of aspects 1-6, where transmitting the non-serving cell beam report further includes: transmitting an indication of the non-serving cell beam report via a number of bits in a beam failure recovery MAC-CE.

Aspect 8: The method of aspect 7, where the number of bits convey information related to one or more PCIs and, for each of the one or more PCIs, one or more component carrier indexes.

Aspect 9: The method of any of aspects 1-8, further including: receiving an indication of a set of beam measurement resources over which the UE is to measure the set of beams associated with the one or more non-serving cells; and measuring a reference signal corresponding to each of the set of beams associated with the one or more non-serving cells over the set of beam measurement resources.

Aspect 10: The method of aspect 9, where measuring the reference signal corresponding to each of the set of beams associated with the one or more non-serving cells further includes: measuring that a respective beam quality of each beam of the set of beams fails to satisfy a quality threshold, where transmitting the resource request associated with the non-serving cell beam report is a result of the respective beam quality of each beam of the set of beams failing to satisfy the quality threshold.

Aspect 11: The method of any of aspects 9 or 10, where measuring the reference signal corresponding to each of the set of beams associated with the one or more non-serving cells further includes: measuring that an average beam quality of the set of beams fails to satisfy a quality threshold, where transmitting the resource request associated with the non-serving cell beam report is a result of the average beam quality of the set of beams failing to satisfy the quality threshold.

Aspect 12: The method of aspect 9, where measuring the reference signal corresponding to each of the set of beams associated with the one or more non-serving cells further includes: measuring that an average beam quality of the set of beams satisfies a quality threshold, where transmitting the resource request associated with the non-serving cell beam report is a result of the average beam quality of the set of beams satisfying the quality threshold.

Aspect 13: The method of any of aspects 9-12, where measuring the reference signal corresponding to each of the set of beams associated with the one or more non-serving cells further includes: measuring that an average beam quality of the set of beams has changed greater than a threshold amount relative to a previous average beam quality of the set of beams obtained from a previous measurement, where transmitting the resource request associated with the non-serving cell beam report is a result of the average beam quality of the set of beams changing greater than the threshold amount relative to the previous average beam quality of the set of beams obtained from the previous measurement.

Aspect 14: The method of any of aspects 1-13, where the resource request associated with the non-serving cell beam report includes one or both of a scheduling request or a MAC-CE.

Aspect 15: The method of any of aspects 1-14, where the non-serving cell beam report is transmitted via a MAC-CE, UCI, an L3 measurement report, or any combination thereof.

Aspect 16: A method for wireless communication at a network entity, including: receiving, from a UE, a resource request associated with a non-serving cell beam report; transmitting, to the UE and responsive to the resource request, a request for the non-serving cell beam report; and receiving, from the UE, the non-serving cell beam report, where the non-serving cell beam report conveys beam quality information for a set of beams associated with one or more non-serving cells.

Aspect 17: The method of aspect 16, where receiving the resource request associated with the non-serving cell beam report further includes: receiving an indication of a configuration identifier for the non-serving cell beam report.

Aspect 18: The method of any of aspects 16 or 17, where transmitting the request for the non-serving cell beam report includes: transmitting an indication of a set of resources over which the UE is to transmit the non-serving cell beam report, where the non-serving cell beam report is received over the set of resources in accordance with the request for the non-serving cell beam report.

Aspect 19: The method of any of aspects 16-18, where transmitting the request for the non-serving cell beam report includes transmitting an indication of a content to be included in the non-serving cell beam report; and receiving the non-serving cell beam report in accordance with the request includes receiving a beam index for each beam of the set of beams and, for each beam of the set of beams, an RSRP measurement in accordance with the content indicated by the request for the non-serving cell beam report.

Aspect 20: The method of any of aspects 16-19, where receiving the non-serving cell beam report further includes: receiving an indication of the non-serving cell beam report via a number of bits in a beam failure recovery MAC-CE.

Aspect 21: The method of aspect 20, where the number of bits convey information related to one or more PCIs and, for each of the one or more PCIs, one or more component carrier indexes.

Aspect 22: The method of any of aspects 16-21, further including: transmitting an indication of a set of beam measurement resources over which the UE is to measure the set of beams associated with the one or more non-serving cells, where receiving the resource request associated with the non-serving cell beam report is a result of transmitting the indication of the set of beam measurement resources.

Aspect 23: The method of any of aspects 16-22, where the non-serving cell beam report indicates that a respective beam quality of each beam of the set of beams fails to satisfy a quality threshold, and receiving the resource request associated with the non-serving cell beam report is a result of the respective beam quality of each beam of the set of beams failing to satisfy the quality threshold.

Aspect 24: The method of any of aspects 16-23, where the non-serving cell beam report indicates that an average beam quality of the set of beams fails to satisfy a quality threshold, and receiving the resource request associated with the non-serving cell beam report is a result of the average beam quality of the set of beams failing to satisfy the quality threshold.

Aspect 25: The method of any of aspects 16-22, where the non-serving cell beam report indicates that an average beam quality of the set of beams satisfies a quality threshold, and receiving the resource request associated with the non-serving cell beam report is a result of the average beam quality of the set of beams satisfying the quality threshold.

Aspect 26: The method of any of aspects 16-25, where the non-serving cell beam report indicates that an average beam quality of the set of beams has changed greater than a threshold amount relative to a previous average beam quality of the set of beams obtained from a previous measurement, and receiving the resource request associated with the non-serving cell beam report is a result of the average beam quality of the set of beams changing greater than the threshold amount relative to the previous average beam quality of the set of beams obtained from the previous measurement.

Aspect 27: The method of any of aspects 16-26, where the resource request associated with the non-serving cell beam report includes one or both of a scheduling request or a MAC-CE.

Aspect 28: The method of any of aspects 16-27, where the non-serving cell beam report is received via a MAC-CE, UCI, an L3 measurement report, or any combination thereof.

Aspect 29: An apparatus for wireless communication at a UE, including: a first interface configured to output a resource request associated with a non-serving cell beam report; the first interface or a second interface configured to obtain, responsive to the resource request, a request for the non-serving cell beam report; and the first interface or the second interface configured to output the non-serving cell beam report, where the non-serving cell beam report conveys beam quality information for a set of beams associated with one or more non-serving cells.

Aspect 30: The apparatus of aspect 29, where outputting the resource request associated with the non-serving cell beam report further includes: outputting an indication of a configuration identifier for the non-serving cell beam report.

Aspect 31: The apparatus of any of aspects 29 or 30, where obtaining the request for the non-serving cell beam report includes: obtaining an indication of a set of resources over which the UE is to output the non-serving cell beam report, where the non-serving cell beam report is output over the set of resources in accordance with the request for the non-serving cell beam report.

Aspect 32: The apparatus of any of aspects 29-31, where obtaining the request for the non-serving cell beam report includes obtaining an indication of a content to be included in the non-serving cell beam report; and outputting the non-serving cell beam report in accordance with the request includes outputting a beam index for each beam of the set of beams and, for each beam of the set of beams, an RSRP measurement in accordance with the content indicated by the request for the non-serving cell beam report.

Aspect 33: The apparatus of any of aspects 29-32, where: a processing system is configured to start a timer as a result of outputting the resource request; and where the first interface or the second interface is configured to refrain from outputting any other resource requests associated with non-serving cell beam reports for a duration of the timer.

Aspect 34: The apparatus of any of aspects 29-33, where: a processing system is configured to start a timer as a result of outputting the non-serving cell beam report; and where the first interface or the second interface is configured to refrain from outputting any other non-serving cell beam reports for a duration of the timer.

Aspect 35: The apparatus of any of aspects 29-34, where outputting the non-serving cell beam report further includes: outputting an indication of the non-serving cell beam report via a number of bits in a beam failure recovery MAC-CE.

Aspect 36: The apparatus of aspect 35, where the number of bits convey information related to one or more PCIs and, for each of the one or more PCIs, one or more component carrier indexes.

Aspect 37: The apparatus of any of aspects 29-36, where: the first interface or the second interface is configured to obtain an indication of a set of beam measurement resources over which the UE is to measure the set of beams associated with the one or more non-serving cells; and a processing system is configured to measure a reference signal corresponding to each of the set of beams associated with the one or more non-serving cells over the set of beam measurement resources.

Aspect 38: The apparatus of aspect 37, where measuring the reference signal corresponding to each of the set of beams associated with the one or more non-serving cells further includes: measuring that a respective beam quality of each beam of the set of beams fails to satisfy a quality threshold, where outputting the resource request associated with the non-serving cell beam report is a result of the respective beam quality of each beam of the set of beams failing to satisfy the quality threshold.

Aspect 39: The apparatus of any of aspects 37 or 38, where measuring the reference signal corresponding to each of the set of beams associated with the one or more non-serving cells further includes: measuring that an average beam quality of the set of beams fails to satisfy a quality threshold, where outputting the resource request associated with the non-serving cell beam report is a result of the average beam quality of the set of beams failing to satisfy the quality threshold.

Aspect 40: The apparatus of aspect 37, where measuring the reference signal corresponding to each of the set of beams associated with the one or more non-serving cells further includes: measuring that an average beam quality of the set of beams satisfies a quality threshold, where outputting the resource request associated with the non-serving cell beam report is a result of the average beam quality of the set of beams satisfying the quality threshold.

Aspect 41: The apparatus of any of aspects 37-40, where measuring the reference signal corresponding to each of the set of beams associated with the one or more non-serving cells further includes: measuring that an average beam quality of the set of beams has changed greater than a threshold amount relative to a previous average beam quality of the set of beams obtained from a previous measurement, where outputting the resource request associated with the non-serving cell beam report is a result of the average beam quality of the set of beams changing greater than the threshold amount relative to the previous average beam quality of the set of beams obtained from the previous measurement.

Aspect 42: The apparatus of any of aspects 29-41, where the resource request associated with the non-serving cell beam report includes one or both of a scheduling request or a MAC-CE.

Aspect 43: The apparatus of any of aspects 29-42, where the non-serving cell beam report is output via a MAC-CE, UCI, an L3 measurement report, or any combination thereof.

Aspect 44: An apparatus for wireless communication at a network entity, including: a first interface configured to obtain, from a UE, a resource request associated with a non-serving cell beam report; the first interface or a second interface configured to output, to the UE and responsive to the resource request, a request for the non-serving cell beam report; and the first interface or the second interface configured to obtain, from the UE, the non-serving cell beam report, where the non-serving cell beam report conveys beam quality information for a set of beams associated with one or more non-serving cells.

Aspect 45: The apparatus of aspect 44, where obtaining the resource request associated with the non-serving cell beam report further includes: obtaining an indication of a configuration identifier for the non-serving cell beam report.

Aspect 46: The apparatus of any of aspects 44 or 45, where outputting the request for the non-serving cell beam report includes: outputting an indication of a set of resources over which the UE is to transmit the non-serving cell beam report, where the non-serving cell beam report is obtained over the set of resources in accordance with the request for the non-serving cell beam report.

Aspect 47: The apparatus of any of aspects 44-46, where outputting the request for the non-serving cell beam report includes outputting an indication of a content to be included in the non-serving cell beam report; and obtaining the non-serving cell beam report in accordance with the request includes obtaining a beam index for each beam of the set of beams and, for each beam of the set of beams, an RSRP measurement in accordance with the content indicated by the request for the non-serving cell beam report.

Aspect 48: The apparatus of any of aspects 44-47, where obtaining the non-serving cell beam report further includes: obtaining an indication of the non-serving cell beam report via a number of bits in a beam failure recovery MAC-CE.

Aspect 49: The apparatus of aspect 20, where the number of bits convey information related to one or more PCIs and, for each of the one or more PCIs, one or more component carrier indexes.

Aspect 50: The apparatus of any of aspects 44-49, where: the first interface or the second interface is further configured to output an indication of a set of beam measurement resources over which the UE is to measure the set of beams associated with the one or more non-serving cells, where obtaining the resource request associated with the non-serving cell beam report is a result of outputting the indication of the set of beam measurement resources.

Aspect 51: The apparatus of any of aspects 44-50, where the non-serving cell beam report indicates that a respective beam quality of each beam of the set of beams fails to satisfy a quality threshold, and obtaining the resource request associated with the non-serving cell beam report is a result of the respective beam quality of each beam of the set of beams failing to satisfy the quality threshold.

Aspect 52: The apparatus of any of aspects 44-51, where the non-serving cell beam report indicates that an average beam quality of the set of beams fails to satisfy a quality threshold, and obtaining the resource request associated with the non-serving cell beam report is a result of the average beam quality of the set of beams failing to satisfy the quality threshold.

Aspect 53: The apparatus of any of aspects 44-50, where the non-serving cell beam report indicates that an average beam quality of the set of beams satisfies a quality threshold, and obtaining the resource request associated with the non-serving cell beam report is a result of the average beam quality of the set of beams satisfying the quality threshold.

Aspect 54: The apparatus of any of aspects 44-53, where the non-serving cell beam report indicates that an average beam quality of the set of beams has changed greater than a threshold amount relative to a previous average beam quality of the set of beams obtained from a previous measurement, and obtaining the resource request associated with the non-serving cell beam report is a result of the average beam quality of the set of beams changing greater than the threshold amount relative to the previous average beam quality of the set of beams obtained from the previous measurement.

Aspect 55: The apparatus of any of aspects 44-54, where the resource request associated with the non-serving cell beam report includes one or both of a scheduling request or a MAC-CE.

Aspect 56: The apparatus of any of aspects 44-55, where the non-serving cell beam report is obtained via a MAC-CE, UCI, an L3 measurement report, or any combination thereof.

Aspect 57: An apparatus for wireless communication at a UE, including: means for transmitting a resource request associated with a non-serving cell beam report; means for receiving, responsive to the resource request, a request for the non-serving cell beam report; and means for transmitting the non-serving cell beam report, where the non-serving cell beam report conveys beam quality information for a set of beams associated with one or more non-serving cells.

Aspect 58: The apparatus of aspect 57, where the means for transmitting the resource request associated with the non-serving cell beam report further include: means for transmitting an indication of a configuration identifier for the non-serving cell beam report.

Aspect 59: The apparatus of any of aspects 57 or 58, where the means for receiving the request for the non-serving cell beam report include: means for receiving an indication of a set of resources over which the UE is to transmit the non-serving cell beam report, where the non-serving cell beam report is transmitted over the set of resources in accordance with the request for the non-serving cell beam report.

Aspect 60: The apparatus of any of aspects 57-59, where the means for receiving the request for the non-serving cell beam report include means for receiving an indication of a content to be included in the non-serving cell beam report; and the means for transmitting the non-serving cell beam report include means for transmitting a beam index for each beam of the set of beams and, for each beam of the set of beams, an RSRP measurement in accordance with the content indicated by the request for the non-serving cell beam report.

Aspect 61: The apparatus of any of aspects 57-60, further including: means for starting a timer as a result of transmitting the resource request; and means for refraining from transmitting any other resource requests associated with non-serving cell beam reports for a duration of the timer.

Aspect 62: The apparatus of any of aspects 57-61, further including: means for starting a timer as a result of transmitting the non-serving cell beam report; and means for refraining from transmitting any other non-serving cell beam reports for a duration of the timer.

Aspect 63: The apparatus of any of aspects 57-62, where the means for transmitting the non-serving cell beam report further include: means for transmitting an indication of the non-serving cell beam report via a number of bits in a beam failure recovery MAC-CE.

Aspect 64: The apparatus of aspect 63, where the number of bits convey information related to one or more PCIs and, for each of the one or more PCIs, one or more component carrier indexes.

Aspect 65: The apparatus of any of aspects 57-64, further including: means for receiving an indication of a set of beam measurement resources over which the UE is to measure the set of beams associated with the one or more non-serving cells; and means for measuring a reference signal corresponding to each of the set of beams associated with the one or more non-serving cells over the set of beam measurement resources.

Aspect 66: The apparatus of aspect 65, where the means for measuring the reference signal corresponding to each of the set of beams associated with the one or more non-serving cells further include: means for measuring that a respective beam quality of each beam of the set of beams fails to satisfy a quality threshold, where transmitting the resource request associated with the non-serving cell beam report is a result of the respective beam quality of each beam of the set of beams failing to satisfy the quality threshold.

Aspect 67: The apparatus of any of aspects 65 or 66, where the means for measuring the reference signal corresponding to each of the set of beams associated with the one or more non-serving cells further include: means for measuring that an average beam quality of the set of beams fails to satisfy a quality threshold, where transmitting the resource request associated with the non-serving cell beam report is a result of the average beam quality of the set of beams failing to satisfy the quality threshold.

Aspect 68: The apparatus of aspect 65, where the means for measuring the reference signal corresponding to each of the set of beams associated with the one or more non-serving cells further include: means for measuring that an average beam quality of the set of beams satisfies a quality threshold, where transmitting the resource request associated with the non-serving cell beam report is a result of the average beam quality of the set of beams satisfying the quality threshold.

Aspect 69: The apparatus of any of aspects 65-68, where the means for measuring the reference signal corresponding to each of the set of beams associated with the one or more non-serving cells further include: means for measuring that an average beam quality of the set of beams has changed greater than a threshold amount relative to a previous average beam quality of the set of beams obtained from a previous measurement, where transmitting the resource request associated with the non-serving cell beam report is a result of the average beam quality of the set of beams changing greater than the threshold amount relative to the previous average beam quality of the set of beams obtained from the previous measurement.

Aspect 70: The apparatus of any of aspects 57-69, where the resource request associated with the non-serving cell beam report includes one or both of a scheduling request or a MAC-CE.

Aspect 71: The apparatus of any of aspects 57-70, where the non-serving cell beam report is transmitted via a MAC-CE, UCI, an L3 measurement report, or any combination thereof.

Aspect 72: An apparatus for wireless communication at a network entity, including: means for receiving, from a UE, a resource request associated with a non-serving cell beam report; means for transmitting, to the UE and responsive to the resource request, a request for the non-serving cell beam report; and means for receiving, from the UE, the non-serving cell beam report, where the non-serving cell beam report conveys beam quality information for a set of beams associated with one or more non-serving cells.

Aspect 73: The apparatus of aspect 72, where the means for receiving the resource request associated with the non-serving cell beam report further include: means for receiving an indication of a configuration identifier for the non-serving cell beam report.

Aspect 74: The apparatus of any of aspects 72 or 73, where the means for transmitting the request for the non-serving cell beam report include: means for transmitting an indication of a set of resources over which the UE is to transmit the non-serving cell beam report, where the non-serving cell beam report is received over the set of resources in accordance with the request for the non-serving cell beam report.

Aspect 75: The apparatus of any of aspects 72-74, where the means for transmitting the request for the non-serving cell beam report include means for transmitting an indication of a content to be included in the non-serving cell beam report; and the means for receiving the non-serving cell beam report in accordance with the request include means for receiving a beam index for each beam of the set of beams and, for each beam of the set of beams, an RSRP measurement in accordance with the content indicated by the request for the non-serving cell beam report.

Aspect 76: The apparatus of any of aspects 72-75, where the means for receiving the non-serving cell beam report further include: means for receiving an indication of the non-serving cell beam report via a number of bits in a beam failure recovery MAC-CE.

Aspect 77: The apparatus of aspect 76, where the number of bits convey information related to one or more PCIs and, for each of the one or more PCIs, one or more component carrier indexes.

Aspect 78: The apparatus of any of aspects 72-77, further including: means for transmitting an indication of a set of beam measurement resources over which the UE is to measure the set of beams associated with the one or more non-serving cells, where receiving the resource request associated with the non-serving cell beam report is a result of transmitting the indication of the set of beam measurement resources.

Aspect 79: The apparatus of any of aspects 72-78, where the non-serving cell beam report indicates that a respective beam quality of each beam of the set of beams fails to satisfy a quality threshold, and receiving the resource request associated with the non-serving cell beam report is a result of the respective beam quality of each beam of the set of beams failing to satisfy the quality threshold.

Aspect 80: The apparatus of any of aspects 72-79, where the non-serving cell beam report indicates that an average beam quality of the set of beams fails to satisfy a quality threshold, and receiving the resource request associated with the non-serving cell beam report is a result of the average beam quality of the set of beams failing to satisfy the quality threshold.

Aspect 81: The apparatus of any of aspects 72-78, where the non-serving cell beam report indicates that an average beam quality of the set of beams satisfies a quality threshold, and receiving the resource request associated with the non-serving cell beam report is a result of the average beam quality of the set of beams satisfying the quality threshold.

Aspect 82: The apparatus of any of aspects 72-81, where the non-serving cell beam report indicates that an average beam quality of the set of beams has changed greater than a threshold amount relative to a previous average beam quality of the set of beams obtained from a previous measurement, and receiving the resource request associated with the non-serving cell beam report is a result of the average beam quality of the set of beams changing greater than the threshold amount relative to the previous average beam quality of the set of beams obtained from the previous measurement.

Aspect 83: The apparatus of any of aspects 72-82, where the resource request associated with the non-serving cell beam report includes one or both of a scheduling request or a MAC-CE.

Aspect 84: The apparatus of any of aspects 72-83, where the non-serving cell beam report is received via a MAC-CE, UCI, an L3 measurement report, or any combination thereof.

Aspect 85: A non-transitory computer-readable medium storing code for wireless communication at a UE, the code including instructions executable by a processor to transmit a resource request associated with a non-serving cell beam report; receive, responsive to the resource request, a request for the non-serving cell beam report; and transmit the non-serving cell beam report, where the non-serving cell beam report conveys beam quality information for a set of beams associated with one or more non-serving cells.

Aspect 86: The non-transitory computer-readable medium of aspect 85, where the instructions to transmit the resource request associated with the non-serving cell beam report are further executable by the processor to: transmit an indication of a configuration identifier for the non-serving cell beam report.

Aspect 87: The non-transitory computer-readable medium of any of aspects 85 or 86, where the instructions to receive the request for the non-serving cell beam report are executable by the processor to: receive an indication of a set of resources over which the UE is to transmit the non-serving cell beam report, where the non-serving cell beam report is transmitted over the set of resources in accordance with the request for the non-serving cell beam report.

Aspect 88: The non-transitory computer-readable medium of any of aspects 85-87, where receiving the request for the non-serving cell beam report includes receiving an indication of a content to be included in the non-serving cell beam report; and transmitting the non-serving cell beam report in accordance with the request includes transmitting a beam index for each beam of the set of beams and, for each beam of the set of beams, an RSRP measurement in accordance with the content indicated by the request for the non-serving cell beam report.

Aspect 89: The non-transitory computer-readable medium of any of aspects 85-88, where the instructions are further executable by the processor to: start a timer as a result of transmitting the resource request; and refrain from transmitting any other resource requests associated with non-serving cell beam reports for a duration of the timer.

Aspect 90: The non-transitory computer-readable medium of any of aspects 85-89, where the instructions are further executable by the processor to: start a timer as a result of transmitting the non-serving cell beam report; and refrain from transmitting any other non-serving cell beam reports for a duration of the timer.

Aspect 91: The non-transitory computer-readable medium of any of aspects 85-90, where the instructions to transmit the non-serving cell beam report are further executable by the processor to: transmit an indication of the non-serving cell beam report via a number of bits in a beam failure recovery MAC-CE.

Aspect 92: The non-transitory computer-readable medium of aspect 91, where the number of bits convey information related to one or more PCIs and, for each of the one or more PCIs, one or more component carrier indexes.

Aspect 93: The non-transitory computer-readable medium of any of aspects 85-92, where the instructions are further executable by the processor to: receive an indication of a set of beam measurement resources over which the UE is to measure the set of beams associated with the one or more non-serving cells; and measure a reference signal corresponding to each of the set of beams associated with the one or more non-serving cells over the set of beam measurement resources.

Aspect 94: The non-transitory computer-readable medium of aspect 93, where the instructions to measure the reference signal corresponding to each of the set of beams associated with the one or more non-serving cells are further executable by the processor to: measure that a respective beam quality of each beam of the set of beams fails to satisfy a quality threshold, where transmitting the resource request associated with the non-serving cell beam report is a result of the respective beam quality of each beam of the set of beams failing to satisfy the quality threshold.

Aspect 95: The non-transitory computer-readable medium of any of aspects 93 or 94, where the instructions to measure the reference signal corresponding to each of the set of beams associated with the one or more non-serving cells are further executable by the processor to: measure that an average beam quality of the set of beams fails to satisfy a quality threshold, where transmitting the resource request associated with the non-serving cell beam report is a result of the average beam quality of the set of beams failing to satisfy the quality threshold.

Aspect 96: The non-transitory computer-readable medium of aspect 93, where the instructions to measure the reference signal corresponding to each of the set of beams associated with the one or more non-serving cells are further executable by the processor to: measure that an average beam quality of the set of beams satisfies a quality threshold, where transmitting the resource request associated with the non-serving cell beam report is a result of the average beam quality of the set of beams satisfying the quality threshold.

Aspect 97: The non-transitory computer-readable medium of any of aspects 93-96, where the instructions to measure the reference signal corresponding to each of the set of beams associated with the one or more non-serving cells are further executable by the processor to: measure that an average beam quality of the set of beams has changed greater than a threshold amount relative to a previous average beam quality of the set of beams obtained from a previous measurement, where transmitting the resource request associated with the non-serving cell beam report is a result of the average beam quality of the set of beams changing greater than the threshold amount relative to the previous average beam quality of the set of beams obtained from the previous measurement.

Aspect 98: The non-transitory computer-readable medium of any of aspects 85-91, where the resource request associated with the non-serving cell beam report includes one or both of a scheduling request or a MAC-CE.

Aspect 99: The non-transitory computer-readable medium of any of aspects 85-98, where the non-serving cell beam report is transmitted via a MAC-CE, UCI, an L3 measurement report, or any combination thereof.

Aspect 100: A non-transitory computer-readable medium storing code for wireless communication at a network entity, the code including instructions executable by a processor to receive, from a UE, a resource request associated with a non-serving cell beam report; transmit, to the UE and responsive to the resource request, a request for the non-serving cell beam report; and receive, from the UE, the non-serving cell beam report, where the non-serving cell beam report conveys beam quality information for a set of beams associated with one or more non-serving cells.

Aspect 101: The non-transitory computer-readable medium of aspect 100, where the instructions to receive the resource request associated with the non-serving cell beam report are further executable by the processor to: receive an indication of a configuration identifier for the non-serving cell beam report.

Aspect 102: The non-transitory computer-readable medium of any of aspects 100 or 101, where the instructions to transmit the request for the non-serving cell beam report are executable by the processor to: transmit an indication of a set of resources over which the UE is to transmit the non-serving cell beam report, where the non-serving cell beam report is received over the set of resources in accordance with the request for the non-serving cell beam report.

Aspect 103: The non-transitory computer-readable medium of any of aspects 100-102, where transmitting the request for the non-serving cell beam report includes transmitting an indication of a content to be included in the non-serving cell beam report; and receiving the non-serving cell beam report in accordance with the request includes receiving a beam index for each beam of the set of beams and, for each beam of the set of beams, an RSRP measurement in accordance with the content indicated by the request for the non-serving cell beam report.

Aspect 104: The non-transitory computer-readable medium of any of aspects 100-103, where the instructions to receive the non-serving cell beam report are further executable by the processor to: receive an indication of the non-serving cell beam report via a number of bits in a beam failure recovery MAC-CE.

Aspect 105: The non-transitory computer-readable medium of aspect 104, where the number of bits convey information related to one or more PCIs and, for each of the one or more PCIs, one or more component carrier indexes.

Aspect 106: The non-transitory computer-readable medium of any of aspects 100-105, where the instructions are further executable by the processor to: transmit an indication of a set of beam measurement resources over which the UE is to measure the set of beams associated with the one or more non-serving cells, where receiving the resource request associated with the non-serving cell beam report is a result of transmitting the indication of the set of beam measurement resources.

Aspect 107: The non-transitory computer-readable medium of any of aspects 100-106, where the non-serving cell beam report indicates that a respective beam quality of each beam of the set of beams fails to satisfy a quality threshold, and receiving the resource request associated with the non-serving cell beam report is a result of the respective beam quality of each beam of the set of beams failing to satisfy the quality threshold.

Aspect 108: The non-transitory computer-readable medium of any of aspects 100-107, where the non-serving cell beam report indicates that an average beam quality of the set of beams fails to satisfy a quality threshold, and receiving the resource request associated with the non-serving cell beam report is a result of the average beam quality of the set of beams failing to satisfy the quality threshold.

Aspect 109: The non-transitory computer-readable medium of any of aspects 100-106, where the non-serving cell beam report indicates that an average beam quality of the set of beams satisfies a quality threshold, and receiving the resource request associated with the non-serving cell beam report is a result of the average beam quality of the set of beams satisfying the quality threshold.

Aspect 110: The non-transitory computer-readable medium of any of aspects 100-109, where the non-serving cell beam report indicates that an average beam quality of the set of beams has changed greater than a threshold amount relative to a previous average beam quality of the set of beams obtained from a previous measurement, and receiving the resource request associated with the non-serving cell beam report is a result of the average beam quality of the set of beams changing greater than the threshold amount relative to the previous average beam quality of the set of beams obtained from the previous measurement.

Aspect 111: The non-transitory computer-readable medium of any of aspects 100-110, where the resource request associated with the non-serving cell beam report includes one or both of a scheduling request or a MAC-CE.

Aspect 112: The non-transitory computer-readable medium of any of aspects 100-111, where the non-serving cell beam report is received via a MAC-CE, UCI, an L3 measurement report, or any combination thereof.

As used herein, the term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or any processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, such as one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in some combinations and even initially claimed as such, one or more features from a claimed combination can be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some implementations, the actions recited in the claims can be performed in a different order and still achieve desirable results.

What is claimed is:

1. An apparatus for wireless communication at a user equipment (UE), comprising:
a first interface configured to:
output a resource request associated with a non-serving cell beam report;
a second interface configured to:
obtain, responsive to the resource request, a request for the non-serving cell beam report; and
the first interface further configured to:
output the non-serving cell beam report, wherein the non-serving cell beam report conveys beam quality information for a set of beams associated with one or more non-serving cells.

2. The apparatus of claim 1, wherein outputting the resource request associated with the non-serving cell beam report further comprises:
outputting an indication of a configuration identifier for the non-serving cell beam report.

3. The apparatus of claim 1, wherein obtaining the request for the non-serving cell beam report further comprises:
obtaining an indication of a set of resources over which the UE is to output the non-serving cell beam report, wherein the non-serving cell beam report is output over the set of resources in accordance with the request for the non-serving cell beam report.

4. The apparatus of claim 1, wherein:
obtaining the request for the non-serving cell beam report comprises obtaining an indication of a content to be included in the non-serving cell beam report; and
outputting the non-serving cell beam report in accordance with the request comprises outputting a beam index for each beam of the set of beams and, for each beam of the set of beams, a reference signal receive power (RSRP) measurement in accordance with the content indicated by the request for the non-serving cell beam report.

5. The apparatus of claim 1, wherein:
a processing system is configured to:
start a timer as a result of outputting the resource request; and
the first interface is configured to:
refrain from outputting any other resource requests associated with non-serving cell beam reports for a duration of the timer.

6. The apparatus of claim 1, wherein:
a processing system is configured to:
start a timer as a result of outputting the non-serving cell beam report; and
the first interface is configured to:
refrain from outputting any other non-serving cell beam reports for a duration of the timer.

7. The apparatus of claim 1, wherein outputting the non-serving cell beam report further comprises:
outputting an indication of the non-serving cell beam report via a number of bits in a beam failure recovery medium access control (MAC) control element (MAC-CE).

8. The apparatus of claim 1, wherein:
the second interface is further configured to:
obtain an indication of a set of beam measurement resources over which the UE is to measure the set of beams associated with the one or more non-serving cells; and
a processing system is configured to:
measure a reference signal corresponding to each of the set of beams associated with the one or more non-serving cells over the set of beam measurement resources.

9. The apparatus of claim 8, wherein measuring the reference signal corresponding to each of the set of beams associated with the one or more non-serving cells further comprises:
measuring that a respective beam quality of each beam of the set of beams fails to satisfy a quality threshold, wherein outputting the resource request associated with the non-serving cell beam report is a result of the respective beam quality of each beam of the set of beams failing to satisfy the quality threshold.

10. The apparatus of claim 8, wherein measuring the reference signal corresponding to each of the set of beams associated with the one or more non-serving cells further comprises:
measuring that an average beam quality of the set of beams fails to satisfy a quality threshold, wherein outputting the resource request associated with the non-serving cell beam report is a result of the average beam quality of the set of beams failing to satisfy the quality threshold.

11. The apparatus of claim 8, wherein measuring the reference signal corresponding to each of the set of beams associated with the one or more non-serving cells further comprises:
measuring that an average beam quality of the set of beams satisfies a quality threshold, wherein outputting the resource request associated with the non-serving cell beam report is a result of the average beam quality of the set of beams satisfying the quality threshold.

12. The apparatus of claim 8, wherein measuring the reference signal corresponding to each of the set of beams associated with the one or more non-serving cells further comprises:
measuring that an average beam quality of the set of beams has changed greater than a threshold amount relative to a previous average beam quality of the set of beams obtained from a previous measurement, wherein outputting the resource request associated with the non-serving cell beam report is a result of the average beam quality of the set of beams changing greater than the threshold amount relative to the previous average beam quality of the set of beams obtained from the previous measurement.

13. An apparatus for wireless communication at a network entity, comprising:
a first interface configured to:
obtain, from a user equipment (UE), a resource request associated with a non-serving cell beam report;
a second interface configured to:
output, to the UE and responsive to the resource request, a request for the non-serving cell beam report; and
the first interface configured to:
obtain, from the UE, the non-serving cell beam report, wherein the non-serving cell beam report conveys beam quality information for a set of beams associated with one or more non-serving cells.

14. The apparatus of claim 13, wherein obtaining the resource request associated with the non-serving cell beam report further comprises:
obtaining an indication of a configuration identifier for the non-serving cell beam report.

15. The apparatus of claim 13, wherein outputting the request for the non-serving cell beam report further comprises:
outputting an indication of a set of resources over which the UE is to output the non-serving cell beam report, wherein the non-serving cell beam report is obtained over the set of resources in accordance with the request for the non-serving cell beam report.

16. The apparatus of claim 13, wherein:
outputting the request for the non-serving cell beam report comprises outputting an indication of a content to be included in the non-serving cell beam report; and
obtaining the non-serving cell beam report in accordance with the request comprises obtaining a beam index for each beam of the set of beams and, for each beam of the set of beams, a reference signal receive power (RSRP) measurement in accordance with the content indicated by the request for the non-serving cell beam report.

17. The apparatus of claim 13, wherein obtaining the non-serving cell beam report further comprises:
obtaining an indication of the non-serving cell beam report via a number of bits in a beam failure recovery medium access control (MAC) control element (MAC-CE).

18. The apparatus of claim 13, wherein the second interface is further configured to:
output an indication of a set of beam measurement resources over which the UE is to measure the set of beams associated with the one or more non-serving cells, wherein obtaining the resource request associated with the non-serving cell beam report is a result of outputting the indication of the set of beam measurement resources.

19. The apparatus of claim 13, wherein the non-serving cell beam report indicates that a respective beam quality of each beam of the set of beams fails to satisfy a quality threshold, and obtaining the resource request associated with the non-serving cell beam report is a result of the respective beam quality of each beam of the set of beams failing to satisfy the quality threshold.

20. The apparatus of claim 13, wherein the non-serving cell beam report indicates that an average beam quality of the set of beams fails to satisfy a quality threshold, and obtaining the resource request associated with the non-serving cell beam report is a result of the average beam quality of the set of beams failing to satisfy the quality threshold.

21. The apparatus of claim 13, wherein the non-serving cell beam report indicates that an average beam quality of the set of beams satisfies a quality threshold, and obtaining the resource request associated with the non-serving cell beam report is a result of the average beam quality of the set of beams satisfying the quality threshold.

22. The apparatus of claim 13, wherein the non-serving cell beam report indicates that an average beam quality of the set of beams has changed greater than a threshold amount relative to a previous average beam quality of the set of beams obtained from a previous measurement, and obtaining the resource request associated with the non-serving cell beam report is a result of the average beam quality of the set of beams changing greater than the threshold amount relative to the previous average beam quality of the set of beams obtained from the previous measurement.

23. A method for wireless communication at a user equipment (UE), comprising:
transmitting a resource request associated with a non-serving cell beam report;
receiving, responsive to the resource request, a request for the non-serving cell beam report; and
transmitting the non-serving cell beam report, wherein the non-serving cell beam report conveys beam quality information for a set of beams associated with one or more non-serving cells.

24. The method of claim 23, wherein transmitting the resource request associated with the non-serving cell beam report further comprises:
transmitting an indication of a configuration identifier for the non-serving cell beam report.

25. The method of claim 23, wherein receiving the request for the non-serving cell beam report comprises:
receiving an indication of a set of resources over which the UE is to transmit the non-serving cell beam report, wherein the non-serving cell beam report is transmitted over the set of resources in accordance with the request for the non-serving cell beam report.

26. The method of claim 23, wherein:
receiving the request for the non-serving cell beam report comprises receiving an indication of a content to be included in the non-serving cell beam report; and
transmitting the non-serving cell beam report in accordance with the request comprises transmitting a beam index for each beam of the set of beams and, for each beam of the set of beams, a reference signal receive power (RSRP) measurement in accordance with the content indicated by the request for the non-serving cell beam report.

27. A method for wireless communication at a network entity, comprising:
receiving, from a user equipment (UE), a resource request associated with a non-serving cell beam report;
transmitting, to the UE and responsive to the resource request, a request for the non-serving cell beam report; and
receiving, from the UE, the non-serving cell beam report, wherein the non-serving cell beam report conveys beam quality information for a set of beams associated with one or more non-serving cells.

28. The method of claim 27, wherein receiving the resource request associated with the non-serving cell beam report further comprises:
receiving an indication of a configuration identifier for the non-serving cell beam report.

29. The method of claim 27, wherein transmitting the request for the non-serving cell beam report comprises:
transmitting an indication of a set of resources over which the UE is to transmit the non-serving cell beam report, wherein the non-serving cell beam report is received over the set of resources in accordance with the request for the non-serving cell beam report.

30. The method of claim 27, wherein:
transmitting the request for the non-serving cell beam report comprises transmitting an indication of a content to be included in the non-serving cell beam report; and
receiving the non-serving cell beam report in accordance with the request comprises receiving a beam index for each beam of the set of beams and, for each beam of the set of beams, a reference signal receive power (RSRP) measurement in accordance with the content indicated by the request for the non-serving cell beam report.
